(19) United States
(12) Patent Application Publication
(10) Pub. No.: US 2002/0131457 A1
(43) Pub. Date: Sep. 19, 2002

(54) Cell delay variation absorbing apparatus

(76) Inventor: Hiroyuki Akiyama, Chiba (JP)

Correspondence Address: Robert J. Frank, VENABLE, Post Office Box 34385, Washington, DC, 20043-9998, US

(21) Appl. No.: 09/983,422

(22) Filed: Oct. 24, 2001

(30) Foreign Application Priority Data
Mar. 15, 2001 (JP) 073336/2001

(51) Int. Cl. H04J 3/06

(52) U.S. Cl. 370/519; 370/395.1

(57) ABSTRACT

A trigger state in a cell delay variation absorbing apparatus is set. A value of (a sequence number of a reception packet+1) is inputted from a UUI code holding unit (3) to a reception counter (1). When a state where a call has been set is obtained by a calling setting (115), a counter trigger generating unit (11) generates a counter trigger. When the counter trigger is received, the reception counter starts to count up from the sequence number received from the UUI code holding unit. Thus, the reception counter can be synchronized with the sequence number of the reception packet which is received subsequently.

### BACKGROUND OF THE INVENTION

1. Field of the Invention

The invention relates to a cell delay variation absorbing apparatus for measuring and absorbing a cell delay variation amount on a communication network, particularly, on a network in an apparatus such that a cell delay variation (transmission delay difference between packets) like that of packetized audio data, which can be caused on the network, exercises an influence on communication quality.

2. Related Background Arts

Packetized user information in various services such as frame relay and IP (Internet Protocol) has a peculiar length in accordance with a kind of each service. It is difficult that each of them is communicated in one network, and a peculiar network has to be constructed, so that use efficiency is very low. To solve such a drawback, an ATM cell having a fixed length of 53 bytes is determined as a world standard and a technique such that various packets are mapped to the ATM cells has been developed.

As one of those techniques, there is a technique called AAL5 (ATM Adaptation Layer Type 5: ITU-T I.363.5) for converting a long packet into an ATM cell or a technique called AAL2 (ATM Adaptation Layer Type 2: ITU-T I.363.2) for converting a short packet into an ATM cell.

FIG. 2 is an explanatory diagram showing the AAL5 and AAL2.

As shown in the diagram, the AAL5 is the technique for performing a mutual conversion between the ATM cell and a user packet longer than it, and the AAL2 is the technique for performing a mutual conversion between the ATM cell and a user packet shorter than it.

The AAL2 is the technique developed for transferring a packet of audio data or the like with a short delay time and at high efficiency. A layer of the AAL2 is constructed by two layers.

FIG. 3 is an explanatory diagram of a layer structure.

As shown in the diagram, one of them is a CPS (Common Part Sublayer) layer which plays a role like a common portion which does not depend on a service and the other is an SSCS (Service Specific Convergence Sublayer) layer which plays a peculiar role in dependence on a service. Since the CPS layer is common to each service, it is a main technique of the AAL2 and one layer has been specified as an international standard ITU-T I.363.2. On the other hand, with respect to the SSCS layer which is peculiar to each service, recommendation is being progressed every service. In the recommendation regarding the SSCS, there are ITU-T I.366.1, I.366.2, and the like. The invention relates to an apparatus using a cell delay variation absorption disclosed in ITU-T I.366.2 among them.

The ITU-T I.366.2 has been developed for the purpose of converting audio data or the like communicated by a conventional narrow band network into an ATM cell and transferring it at high efficiency on a wide area network. According to the SSCS layer of the AAL2, the received user information (AAL-SDU: Service Data Unit) is mapped to three kinds of packet formats and a CRC arithmetic operation result is added, thereby protecting against a bit error (two kinds of packet formats among the three kinds are actually protected).

FIG. 4 is an explanatory diagram of a data format of each processing layer and three kinds of packet formats.

A state where the user information has been mapped to the packet format is called SSCS-PDU (Protocol Data Unit) and used for transmitting and receiving it to/from the CPS layer.

With respect to the SSCS layer having a purpose of converting narrow band audio data into the ATM cell, as one of its principle roles, there is a role such that timing (packet interval) of the SSCS-PDU received from the CPS layer is corrected and the AAL-SDU is distributed to the user at regular intervals. Since an ATM network (wide area network) is not time-divided, the cells existing on the network are concentrated to a switch or the like, so that a long waiting time is caused or, when the cell is empty, a state where a waiting time is not caused occurs, and there is a case where a time difference occurs in the transmission of the packet.

There is also a case where the transmission time difference of the packet is also caused at a point when such a conversion into the ATM cell is performed. That is, according to the AAL2 process for converting the short packet into the ATM cell, the ATM cell cannot be filled only by one AAL-SDU, and in the case where the AAL-SDU which will be received after that ought to be mapped to the same ATM cell, an assembly as an ATM cell is completed for the first time. Therefore, there are a case where the assembly is completed earlier than reception timing of the AAL-SDU which will arrive later and a case where the assembly is completed with the elapse of a long time, so that an assembling time difference is caused. Such a delay difference between the packets is called a cell delay variation and becomes a rasping distortion in the audio data and exerts a serious influence on communication quality.

As a method of absorbing the cell delay variation between the packets as mentioned above, there is a method whereby all of the packets cause the maximum delay by applying a surplus delay to information in which the mapping to the ATM cell and the delay in the network are small. To realize such a method, the SSCS layer of the AAL2 uses a UUI (User-to-User Indication) code in a CPS packet header to which assembly and decomposition are performed by the CPS layer.

FIG. 5 shows a format of the CPS packet including the UUI codes.

Inherently, five bits are allocated to the UUI code and the kind of SSCS-PDU which is mapped into the CPS packet can be identified by a code number. For example, code No. 23 denotes the SSCS Type2 packet and code No. 24 denotes the SSCS Type3 packet. However, among the UUI codes, a special using method has been proposed for 0 to 15. By using 0 to 15 as sequence numbers, it is intended to absorb the cell delay variation between the packets. This using method can be used for the SSCS Type1 packet for mainly transmitting audio data.

An example of a cell delay variation absorbing apparatus using the UUI will now be described.

In the bidirectional communication of the audio data, it is assumed that the direction of mapping the audio data to the ATM cell is called a transmitting direction.

FIG. 6 is an explanatory diagram showing an example of a sequence number process of the UUI code in the transmitting direction.

The apparatus in the transmitting direction is shown in the diagram and comprises a counter 101, a header area forming unit 102, and a UUI selector 103. The counter 101 is a 4-bit counter which is counted up at a predetermined period and is a simple counter which is shifted from a state of f(Hex) to a state of 0(Hex). The header area forming unit 102 keeps a CPS header area of three bytes at the head of an inputted Typel packet.

The UUI selector 103 receives an output 110a of the counter 101 and an output 102a of the header area forming unit 102 and inserts the output 110a into a phase corresponding to the UUI code in the header area of the output 102a. At this time, since the output (counter value) 110a consists of 4 bits as compared with all 5 bits of the UUI code, the MSB bit is fixed to 0. An increment period of the UUI code value which is inserted by the circuit construction is determined by a period at which the counter 101 is counted up and a period at which the Type1 packet is inputted. Usually, the period at which the counter 101 is counted up is set by a network administrator (such a period is called a sequence number interval in I.366.2).

The input period of the Type1 packet is equal to an input period of the user information (AAL-SDU). The AAL-SDU is a narrow band network signal, that is, the information obtained by packetizing each user information which has been time-divisionally multiplexed and, usually, the packet is transferred at a rate of 40 octets (64 kbps) per period of 5 msec. However, if the packet is converted as it is into the ATM cell and distributed to the wide area network, transmitting efficiency is not improved as compared with that of the narrow band network (contrarily, the efficiency is deteriorated by an amount corresponding to the ATM header and the CPS header). Therefore, a method of improving a signal compression ratio by using a DSP and, thereafter, converting the packet into the ATM cell is considered. Generally, the packet is transferred at a rate of 10 octets per period of 10 msec by using G.729-8 of the CS-ACELP. As mentioned above, in case of the AAL-SDU, the transfer period is determined by a signal compressing algorithm upon packetization. Such a transfer period is called a packet time in I.366.2.

When considering again by returning to the increment interval in the sequence numbers of the UUI codes, assuming that the count-up period of the counter 101 is equal to 5 msec, if the packet time is equal to 5 msec, the sequence number is incremented to 0, 1, 2, . . . , e, f, 0, . . . . If it is equal to 10 msec, the sequence number is incremented to 0, 2, 4, . . . , e, 0, 2, . . .

FIG. 7 shows such a state.

In the bidirectional communication of the audio data, it is assumed that the direction of decomposing the ATM cell into the audio data is called a receiving direction. A sequence number process of the UUI codes in the receiving direction and an example of the cell delay variation absorption are shown below.

FIG. 8 is a constructional diagram of a cell delay variation absorbing apparatus in the receiving direction.

The above apparatus comprises: a counter 201; a UUI code detecting unit 202; a UUI coincidence discriminating unit 203; a write control unit 204; a memory 205; a read control unit 206; and a dummy inserting unit 207. The UUI code detecting unit 202 detects a reception UUI code value in the case where the inputted SSCS-PDU is received. When the SSCS-PDU is received in a certain state, its value is read to the counter 201 by a signal 202b in which “1” was added to a reception code value. By this reading operation, the UUI code of the reception SSCS-PDU and the counter 201 are synchronized. Since the reception UUI code is not read in a state other than that certain state, the counter 201 is in a self-running state. The term “certain state” mentioned above denotes a state which has arbitrarily been determined and does not indicate a specific state defined in the Recommendation. The “certain state” is called a trigger state here.

The counter 201 operates at the count-up period set by the network administrator in a manner similar to the counter 101 in the transmitting direction and is ordinarily synchronized with the sequence number interval of the reception UUI. The UUI coincidence discriminating unit 203 compares an output 202a of the UUI code detecting unit 202 with an output 201a of the counter 201, detects the coincidence or dissidence, and discriminates whether the received SSCS-PDU could be received without problems or has been received at the timing which was delayed than timing at which it should have been received. Particularly, if it is received at the timing which was delayed than the timing at which it should have been received, information 203a indicative of such a fact is sent to the write control unit 204, thereby preventing the received SSCS-PDU from being written into the memory 205. The discrimination about whether the received SSCS-PDU was delayed than the timing at which it should have been received or not is made by checking whether the UUI code which the received SSCS-PDU has is smaller than the value 201a of the counter 201 or not.

Besides the above write inhibition control, the write control unit 204 notifies the read control unit 206 of the fact that the SSCS-PDU has been written into the memory 205 by a write completion signal 204a. The read control unit 206 controls timing for reading out the SSCS-PDU from the memory 205 by the cell delay variation absorbing time and the packet time which were instructed by the network administrator. The read control is performed by a method similar to that in case of the trigger mentioned above.

The SSCS-PDU received in the trigger state is stored into the memory 205 only for the cell delay variation absorbing time and outputted after that. The subsequent SSCS-PDU is outputted after the elapse of the packet time from the output timing of the one-preceding SSCS-PDU. If the write completion signal 204a is not received at the read timing calculated by the read control unit 206, dummy user information is formed by the dummy inserting unit 207 and distributed. Since the apparatus has a distributing function of the dummy information, the SSCS-PDU which was delayed than the timing at which it should have been received as mentioned above is abandoned because the dummy information in place of it has already been distributed. The dummy information is formed and distributed in order to compensate a state where the user information to be time-divisionally multiplexed has been extinguished due to the loss or the like of the SSCS-PDU.

The above-described apparatus is an apparatus for performing the cell delay variation absorption using the UUI code (ITU-T I.366.2 AAL Type2 Service Specific Convergence Sublayer for narrow-band services).

However, according to the apparatus for absorbing the cell delay variation by the construction as mentioned above, although it is necessary to decide the trigger state in order to make a discrimination about the normality of the reception packet and to absorb the cell delay variation, the trigger state is not specified on the Recommendation but is arbitrarily determined.

Since the network administrator sets the cell delay variation absorption amount, he has to understand an amount of cell delay variation which can be caused on the network. There is a problem such that unless he understands such an amount, the cell delay variation cannot be properly absorbed. The term “proper absorption” denotes an absorption such that a situation in which the SSCS-PDU does not reach when the information should be distributed to the user side due to the lack of the absorption amount does not occur and the loss of real-time performance of the audio data due to the absorption of an amount larger than it is needed does not occur.

### SUMMARY OF THE INVENTION

It is an object of the invention to provide a cell delay variation absorbing apparatus for measuring and absorbing a cell delay variation amount on a communication network, particularly, on a network in an apparatus such that a cell delay variation (transmission delay difference between packets) like that of packetized audio data, which can be caused on the network, exercises an influence on communication quality.

To accomplish the above object, according to the invention, cell delay variation absorbing apparatuses of the following aspects are provided.

<Aspect 1>

A cell delay variation absorbing apparatus in a receiving direction for receiving packets which have sequence numbers and are transmitted at regular intervals and executing a cell delay variation absorbing process of reception timing of the packets, comprising a reception counter which counts the sequence numbers serving as a reference in case of performing the cell delay variation absorbing process of the reception timing of an arbitrary packet and outputs a count value, wherein a process for synchronizing the sequence number which is outputted from the reception counter and the sequence number of the received packet in consideration of a cell delay variation amount is executed by using a predetermined specific condition as a trigger.

<Aspect 2>

In the cell delay variation absorbing apparatus according to Aspect 1, the cell delay variation absorbing process is a process for temporarily writing the received packets into a memory, delaying them by a predetermined time, and sequentially reading out the delayed packets at regular intervals, and in the case where the specific condition is given, the packets are read out from the memory at the timing which was elapsed by the time corresponding to a cell delay variation absorption amount from the writing operation until the end of the synchronizing process, and in a process other than the synchronizing process, the packets are read out from the memory at regular intervals according to a packet time serving as a predetermined packet transmitting interval.

<Aspect 3>

The cell delay variation absorbing apparatus according to Aspect 1 or 2 further comprises: a coincidence loss discriminating unit which discriminates whether the packets have continuously arrived on the basis of the sequence numbers of the packets which are received or not; and a cell delay variation amount calculating unit which calculates an arrival interval between the packets which continuously arrived in the case where it is determined by the coincidence loss discriminating unit that the packets have continuously arrived, and calculates a difference between a value of the calculation and the packet time as a cell delay variation amount.

<Aspect 4>

The cell delay variation absorbing apparatus according to Aspect 3 further comprises a cell delay variation amount holding unit which inputs the cell delay variation amount calculated by the cell delay variation amount calculating unit, compares the inputted value with a previous holding value, updates the cell delay variation amount when the inputted value is larger than the previous value, and holds a maximum cell delay variation amount at that time point.

<Aspect 5>

The cell delay variation absorbing apparatus according to Aspect 3 further comprises a cell delay variation amount holding unit which inputs the cell delay variation amount calculated by the cell delay variation amount calculating unit, compares the inputted value with a previous holding value, updates the cell delay variation amount when the inputted value is smaller than the previous value, and holds the minimum cell delay variation amount at that time point.

<Aspect 6>

A cell delay variation absorbing apparatus in a transmitting direction for transmitting packets having sequence numbers at regular intervals, wherein in a state where a user packet is not communicated, a test packet to which a sequence number is added and which is constructed by a predetermined payload length and a payload pattern and used for measuring a cell delay variation amount is formed, and the test packet is transmitted at regular intervals on the basis of a packet time serving as a predetermined packet transmitting interval.

<Aspect 7>

A cell delay variation absorbing apparatus in a transmitting direction for transmitting packets having sequence numbers at regular intervals, wherein a test packet to which a sequence number is added and which is constructed by a predetermined payload length and a payload pattern, has a pattern indicative of a cell delay variation amount test packet at a position in a predetermined packet, and is used for measuring a cell delay variation amount is formed, and the test packet is transmitted at timing when no user packet exists at regular intervals on the basis of a packet time serving as a predetermined packet transmitting interval.

<Aspect 8>

In the cell delay variation absorbing apparatus according to any one of Aspects 3 to 5, when the test packet to which the sequence number has been added and which has the pattern indicative of the cell delay variation amount test packet at the position in the predetermined packet and is used for measuring the cell delay variation amount is received, by verifying the pattern at the position in the predetermined packet among the packets, it is recognized that this packet is the cell delay variation amount test packet.

<Aspect 9>

The cell delay variation absorbing apparatus according to any one of Aspects 3 to 5 and 8 further comprises: an interval cell delay variation amount holding unit which holds a maximum cell delay variation amount in an arbitrarily determined automatic adjusting interval; and a packet time calculating unit which adds or subtracts a value of a predetermined packet time on the basis of the maximum cell delay variation amount held in the interval cell delay variation amount holding unit and outputs a resultant cell delay variation amount as a packet time for the cell delay variation absorbing process.

<Aspect 10>

A cell delay variation absorbing apparatus in a transmitting direction for transmitting packets having sequence numbers at regular intervals, wherein when a specific condition is given, transmission timing based on a predetermined cell delay variation absorption amount is set into a user packet and, thereafter, the packets are transmitted at regular intervals on the basis of a packet time serving as a predetermined packet transmitting interval.

<Aspect 11>

In the cell delay variation absorbing apparatus according to Aspect 10, an arrival interval of the transmission packet is measured, a difference between a value of the measurement and the predetermined packet time is obtained, and this difference value is used as an amount of cell delay variation which was caused on the user side.

<Aspect 12>

The cell delay variation absorbing apparatus according to Aspect 11 further comprises measuring state designating means which instructs a start and a stop of the measurement of the cell delay variation amount, and wherein a maximum cell delay variation amount in an interval designated by the measuring state designating means is held and the maximum cell delay variation amount is outputted as an amount of a maximum cell delay variation which was caused on the user side.

<Aspect 13>

The cell delay variation absorbing apparatus according to Aspect 11 further comprises measuring state designating means which instructs a start and a stop of the measurement of the cell delay variation amount, and wherein a minimum cell delay variation amount in an interval designated by the measuring state designating means is held and the minimum cell delay variation amount is outputted as an amount of a minimum cell delay variation which was caused on the user side.

<Aspect 14>

In the cell delay variation absorbing apparatus according to any one of Aspects 1, 2, and 10, the specific condition is call setting timing.

<Aspect 15>

In the cell delay variation absorbing apparatus according to any one of Aspects 1, 2, and 10, the specific condition is timing of detecting an alarm state.

<Aspect 16>

In the cell delay variation absorbing apparatus according to any one of Aspects 1, 2, and 10, the specific condition is timing of resetting an alarm state.

<Aspect 17>

In the cell delay variation absorbing apparatus according to any one of Aspects 1, 2, and 10, the specific condition is timing when a dissidence of the UUI codes continues a predetermined number of times or more.

The above and other objects and features of the present invention will become apparent from the following detailed description and the appended claims with reference to the accompanying drawings.

### BRIEF DESCRIPTION OF THE DRAWINGS

FIG. 1 is a constructional diagram of embodiments 1 and 2 of a cell delay variation absorbing apparatus according to the invention;

FIG. 2 is an explanatory diagram showing the AAL5 and AAL2;

FIG. 3 is an explanatory diagram of a layer structure;

FIG. 4 is an explanatory diagram of a data format and three kinds of packet formats of each processing layer;

FIG. 5 is an explanatory diagram of a format of a CPS packet including UUI codes;

FIG. 6 is an explanatory diagram showing an example of a sequence number process of the UUI codes in the transmitting direction;

FIG. 7 is an explanatory diagram of an increment interval in the sequence numbers of the UUI codes;

FIG. 8 is a constructional diagram of a cell delay variation absorbing apparatus in the receiving direction;

FIG. 9 is a timing chart showing a trigger state in the embodiment 1;

FIG. 10 is a timing chart showing the operations of a plurality of packets in the trigger state in the embodiment 1;

FIG. 11 is a constructional diagram of an embodiment 3;

FIG. 12 is a timing chart showing the operations of embodiments 3, 4, and 5;

FIG. 13 is a constructional diagram of the embodiments 4 and 5;

FIG. 14 is a constructional diagram of an embodiment 6;

FIG. 15 is an explanatory diagram showing a format of a test packet which is formed;

FIG. 16 is a timing chart showing the operation of the embodiment 6;

FIG. 17 is a constructional diagram of an embodiment 7;

FIG. 18 is an explanatory diagram of the test packet;

FIG. 19 is a timing chart showing the operation of the embodiment 7;

FIG. 20 is a constructional diagram of an embodiment 8;

FIG. 21 is a timing chart showing the operation of the embodiment 8;

FIG. 22 is a constructional diagram of an embodiment 9;

FIG. 23 is an internal constructional diagram of a packet time calculating unit;

FIG. 24 is a timing chart showing the operation of the embodiment 9;

FIG. 25 is a constructional diagram of an embodiment 10;

FIG. 26 is a constructional diagram of an embodiment 11;

FIG. 27 is a constructional diagram of embodiments 12 and 13; and

FIG. 28 is an explanatory diagram of a format of an alarm packet.

### DETAILED DESCRIPTION OF THE PREFERRED EMBODIMENTS

Embodiments of the present invention will now be described in detail hereinbelow.

[Embodiment 1]

<Construction>

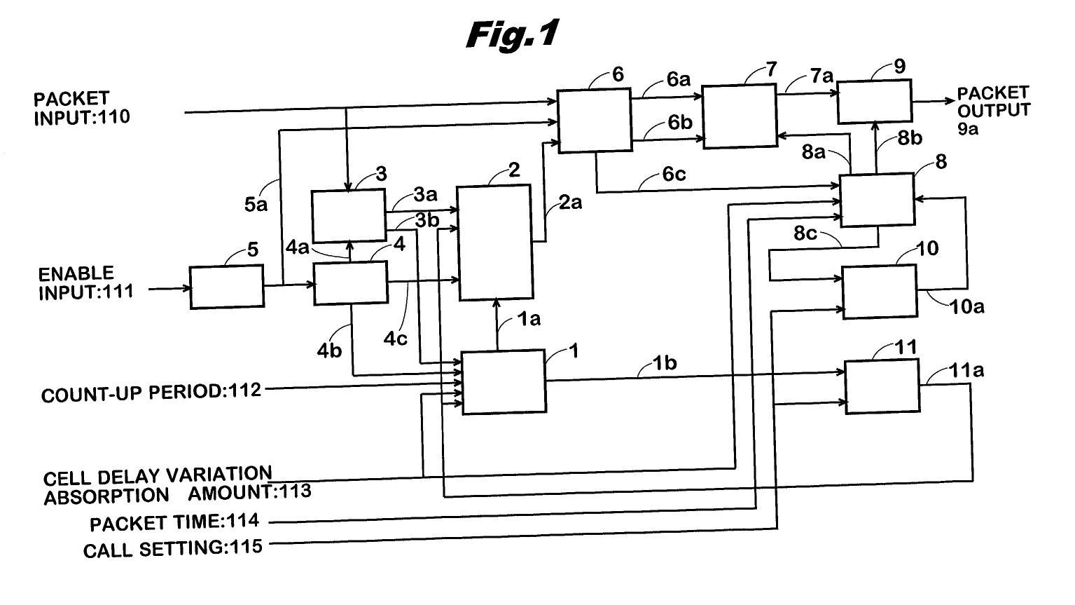

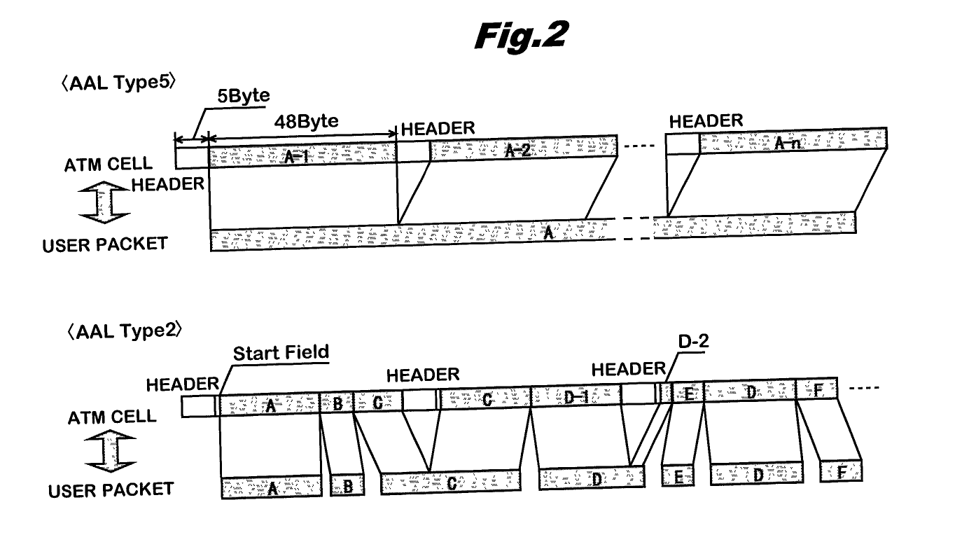

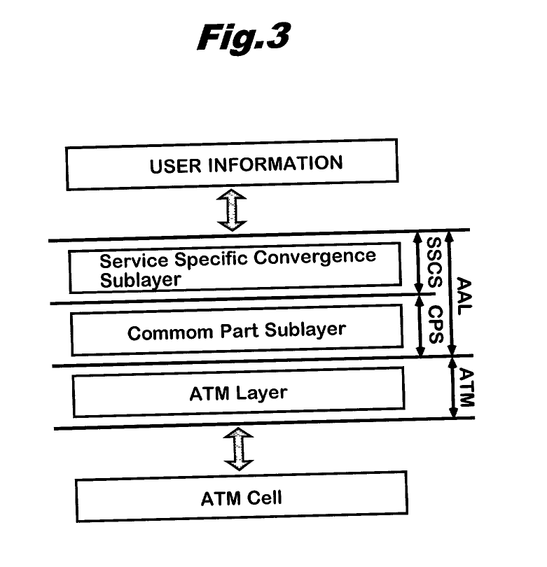

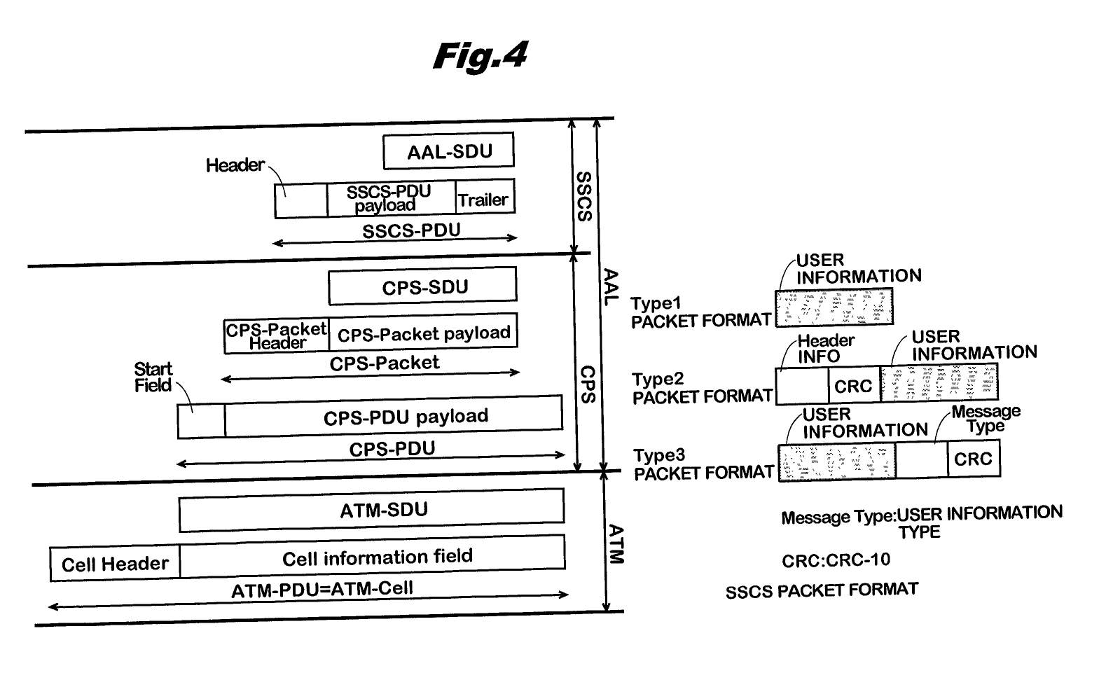

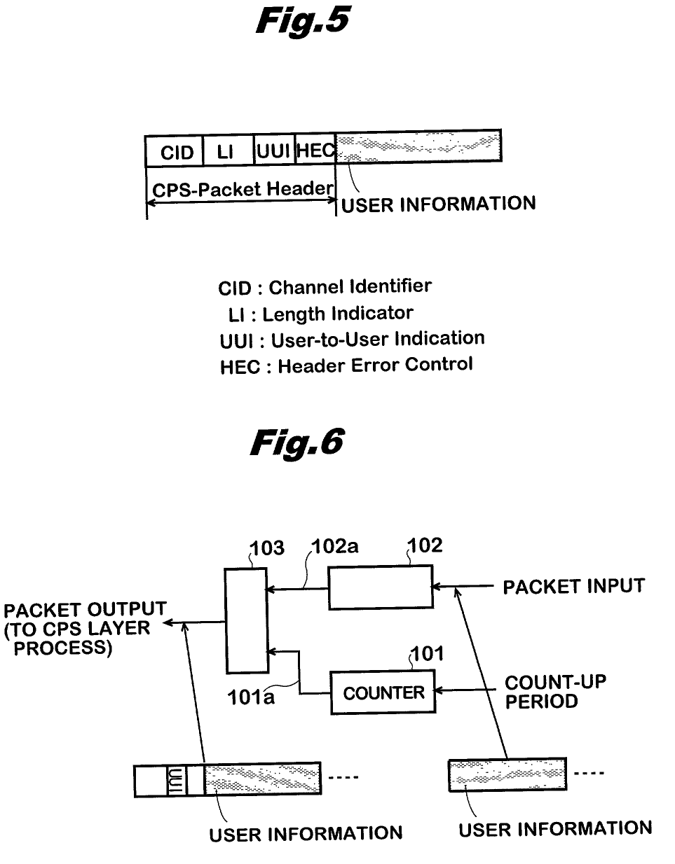

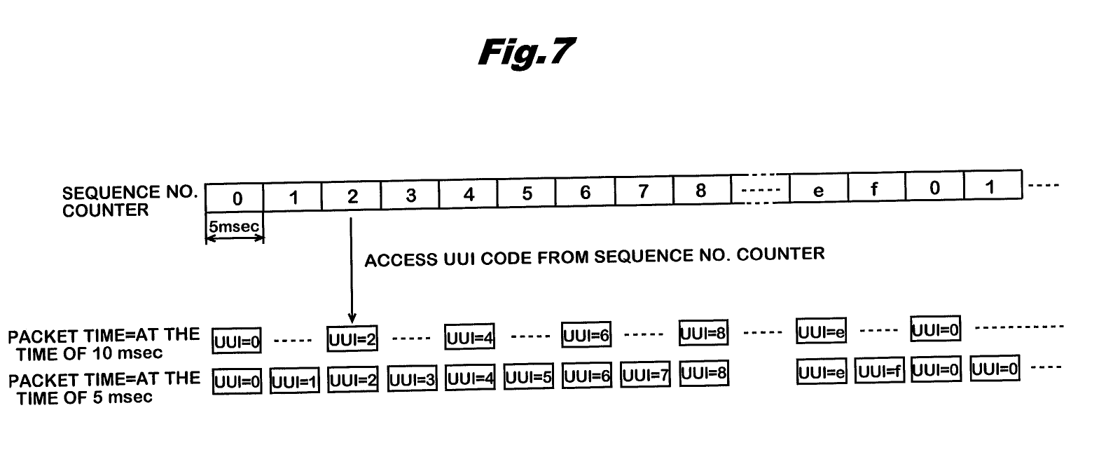

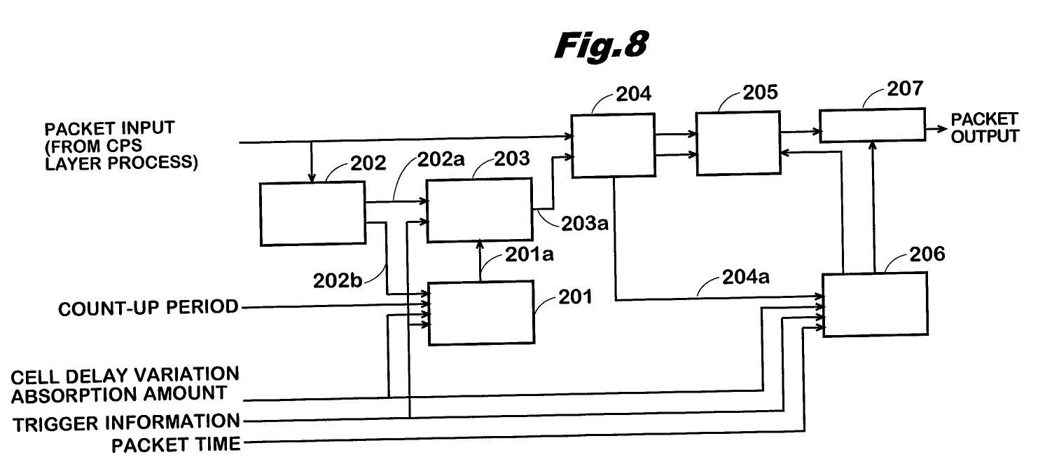

FIG. 1 is a constructional diagram of an embodiment 1 of a cell delay variation absorbing apparatus according to the invention.

The apparatus shown in the diagram comprises: a reception counter 1; a coincidence discriminating unit 2; a UUI code holding unit 3; a decoding unit 4; a phase counter 5; a write control unit 6; a memory 7; a read control unit 8; a dummy inserting unit 9; a read trigger generating unit 10; and a counter trigger generating unit 11.

A packet input 110 is supplied to the UUI code holding unit 3 and write control unit 6. An enable input 111 is supplied to the phase counter 5. Further, a count-up period 112 is supplied to the reception counter 1. A cell delay variation absorption amount 113 and a packet time 114 are supplied to the read control unit 8. A call setting 115 is supplied to the read trigger generating unit 10 and counter trigger generating unit 11.

The reception counter 1 is a counter for inputting a signal 3b which is outputted from the UUI code holding unit 3, a signal 4b which is outputted from the decoding unit 4, the count-up period 112; the cell delay variation absorption amount 113, and a signal 11a which is outputted from the counter trigger generating unit 11 and performing the counting operation on the basis of the count-up period 112. When the signal 11a indicates a trigger state, the reception counter 1 starts to count from a value of the signal 3b at timing of the signal 4b and sends the count value which takes into consideration the cell delay variation absorption amount 113 as a signal 1a to the coincidence discriminating unit 2. The reception counter 1 has a function such that when the reading of the signal 3b from the UUI code holding unit 3 is completed, a signal 1b indicative of the completion of the reading is sent to the counter trigger generating unit 11.

The coincidence discriminating unit 2 is a functional unit for inputting a signal 3a which is outputted from the UUI code holding unit 3, the signal la from the reception counter 1, and the signal 11a from the counter trigger generating unit 11 and discriminating about a coincidence of the reception packet. The coincidence discriminating unit 2 sends a discrimination result indicative of the coincidence or dissidence as a signal 2a to the write control unit 6.

The UUI code holding unit 3 is a functional unit for inputting the packet input 110 and a signal 4a from the decoding unit 4, sending the signal 3a indicative of the UUI code value of the reception packet to the coincidence discriminating unit 2, and sending the signal 3b indicative of the value of (the UUI code value+1) to the reception counter 1.

The decoding unit 4 is a functional unit for transmitting the signals to each unit on the basis of a signal 5a of the phase counter 5 in a manner such that: the signal 4a indicative of the phase of the UUI code existing in a header of the packet is sent to the UUI code holding unit 3; the signal 4b as a timing signal for allowing the reception counter 1 to read the received UUI code value is sent to the reception counter 1; and a signal 4c as a timing signal which is used by the coincidence discriminating unit 2 in order to detect the delayed arrival packet and the packet loss is sent to the coincidence discriminating unit 2.

The phase counter 5 is a functional unit for starting to count up when an enable signal is equal to a value showing the presence of the packet on the basis of the enable input 111 and sending the signal 6a showing a bit phase of the packet to the decoding unit 4 and write control unit 6.

The write control unit 6 is a control unit for inputting the packet input 110, the signal 5a of the phase counter 5, and the signal 2a of the coincidence discriminating unit 2 and performing a write control to the memory 7. The write control unit 6 is also a functional unit for sending signals 6a and 6b to the memory 7 and sending a signal 6c indicative of the completion of the writing to the read control unit 8. When the signal 2a from the coincidence discriminating unit 2 indicates a dissidence state, the writing into the memory 7 is not performed.

The memory 7 is a memory medium for absorbing the cell delay variation of the inputted reception packets and distributing the packets to the user in accordance with the packet time. A write control in this instance is performed from the write control unit 6 and a read control is performed from the read control unit 8.

The read control unit 8 is a control unit for reading out the packets from the memory 7 on the basis of the signal 6c from the write control unit 6, the cell delay variation absorption amount 113, and the packet time 114.

The dummy inserting unit 9 is a functional unit for distributing dummy information as a packet output 9a when it receives a signal 8b of a memory underflow from the read control unit 8 and transmitting the packets read out from the memory 7 as a packet output 9a in the other cases.

The read trigger generating unit 10 is a functional unit constructed in a manner such that it inputs a signal 8c serving as a read start signal which is outputted from the read control unit 8 and the call setting 115, when the call setting 115 indicates a call setting state, a signal 10a serving as a read trigger for the read control unit 8 is set to a trigger state, and when the signal 8c indicates a read start state, the trigger state of the signal 10a is reset.

The counter trigger generating unit 11 is constructed in a manner such that the signal 11a indicative of the trigger state is sent to the reception counter 1 and coincidence discriminating unit 2 on the basis of a signal of the call setting 115 and the trigger state is opened on the basis of the signal 1b indicative of the completion of the reading of the reception counter 1.

<Operation>

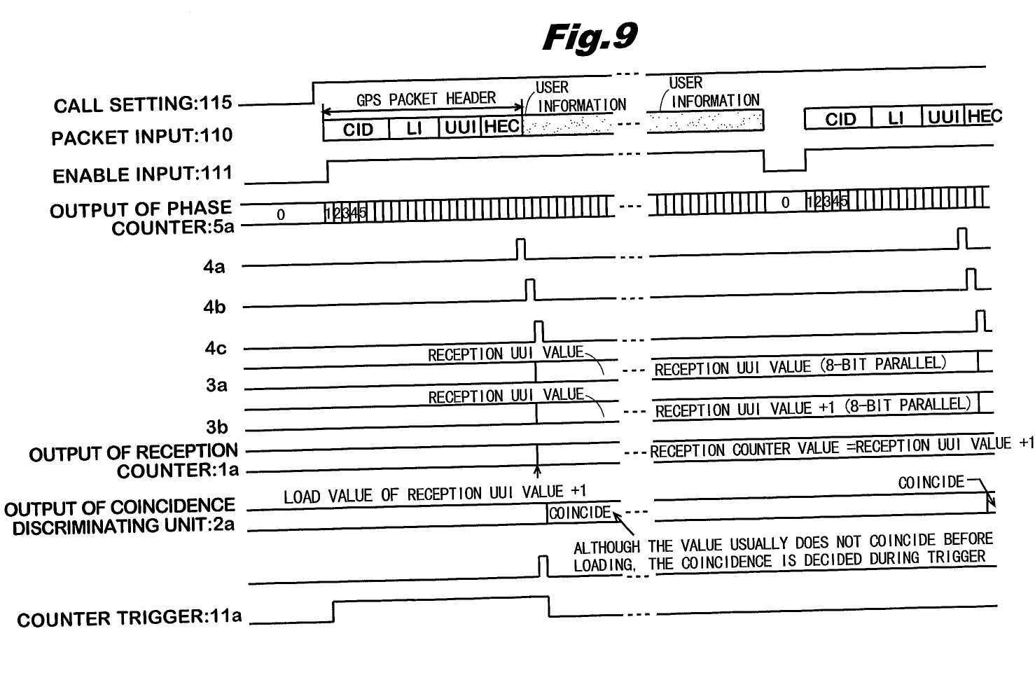

FIG. 9 is a timing chart showing a trigger state in the embodiment 1.

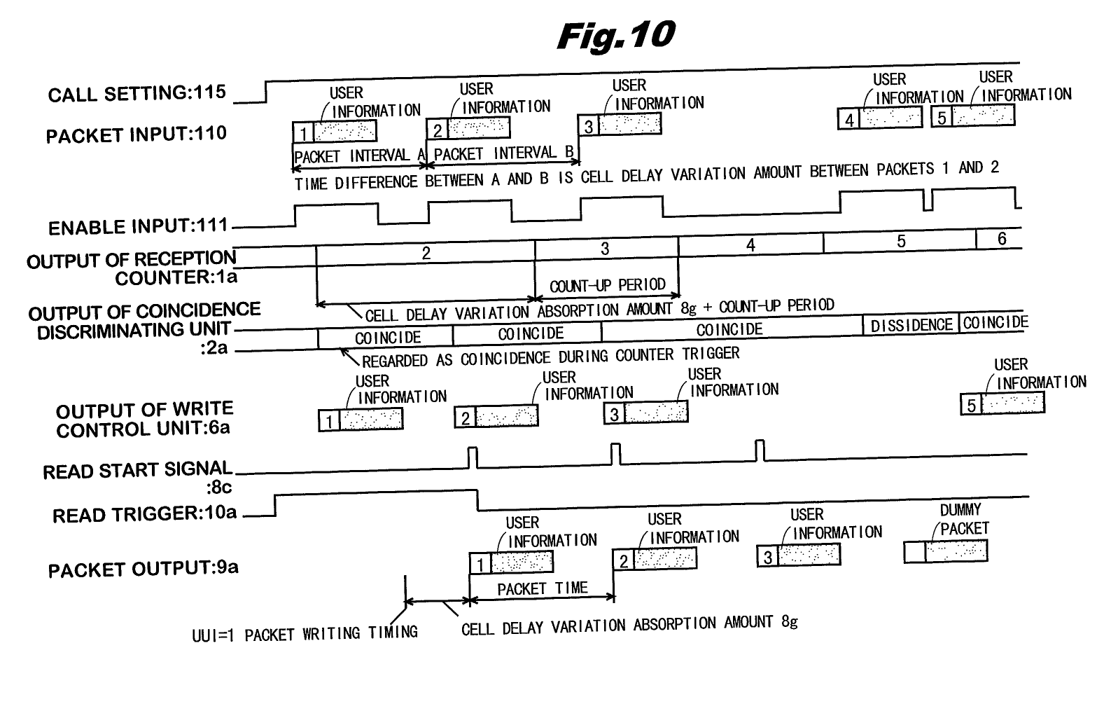

FIG. 10 is a timing chart showing the operations of a plurality of packets in the trigger state in the embodiment 1.

First, the call setting 115 to start communication is set to the call setting state. The call setting 115 is a signal showing that a call has been established in an ordinary telephone line. The counter trigger generating unit 11 sends the signal 11a indicative of the trigger state to the reception counter 1 and coincidence discriminating unit 2 by the input of the call setting 115.

After the input of the call setting 115, the packet having the UUI code number in the CPS packet header is inputted as a packet input 110 and the enable signal synchronized with the packet is inputted as an enable input 111. The enable signal is position information of the packet which is inputted and is a signal showing values such that the phase at which the packet exists is set to H and the other phases are set to L.

The phase counter 5 starts to count up when the enable signal is set to a value indicative of the presence of the packet and performs the operation to indicate the bit phase of the packet. In the embodiment, nothing is considered with respect to a case where the different packets are continuously inputted, and it is presumed that there is a space of at least one bit as a packet interval. If the packets are continuously inputted, a method whereby a signal indicative of the head of the packet is inputted in addition to the enable signal is considered.

The decoding unit 4 receives the signal 5a indicative of the count value of the phase counter 5 and forms the signal 4a showing the phase of the UUI code existing in the header of the packet, the timing signal 4b for allowing the reception counter 1 to read the received UUI code value, and the timing signal 4c for allowing the coincidence discriminating unit 2 to detect the delayed arrival packet and the packet loss.

The UUI code holding unit 3 receives the signal 4a showing the phase of the UUI code and sends the signal 3a showing the UUI code value extracted from the packet of the packet input 110 to the coincidence discriminating unit 2. The unit 3 also sends the signal 3b indicative of the value obtained by adding 1(Hex) to the extracted UUI code value to the reception counter 1.

When the trigger state signal 11a from the counter trigger generating unit 11 is received, the reception counter 1 reads the signal 3b of the UUI code holding unit 3 in response to the signal 4b as a timing signal for reading the UUI code value. By the reading operation, the reception counter 1 is synchronized with the UUI codes of the reception packets which are received subsequently. That is, this is because the signal 3b indicates the value of the UUI code of the reception packet which is received next and the reception counter 1 starts to count up from this value, thereby sending the signal la synchronized with the values of the subsequent UUI codes.

Although the count-up period of the reception counter 1 is instructed on the basis of the count-up period 112, just after completion of the reading, the reception counter 1 starts to count up after the elapse of the time obtained by adding the cell delay variation absorption amount 113 to the time of the count-up period 112 (refer to the reception counter output 1a in FIG. 10). That is, in the trigger state, since which amount of cell delay variation (delay) has been caused is unknown at this time point, the count-up is executed at an interval obtained by adding the cell delay variation absorption amount to the ordinary packet interval.

The coincidence discriminating unit 2 compares the signal 3a showing the reception UUI code value from the UUI code holding unit 3 with the signal la of the reception counter 1, thereby discriminating whether they coincide at the timing signal 4c formed by the decoding unit 4 or not. If a result of the discrimination indicates the dissidence, the coincidence discriminating unit 2 outputs dissidence information. However, when the signal from the counter trigger generating unit 11 indicates the trigger state, the information is not outputted. This is because it is intended to write the reception packet in the trigger state into the memory 7.

The write control unit 6 adjusts the timing for writing the reception packet of the packet input 110 into the memory 7 and sends the packet as a signal 6a to the memory 7. The write control unit 6 forms the control signal 6b on the basis of the signal 5a from the phase counter 5, writes the packet into the memory 7, and outputs the write completion signal 6c to the read control unit 8 at the end of the writing. If the signal 2a from the coincidence discriminating unit 2 indicates the dissidence state, the reception packet is not written.

Upon completion of the reading of the signal 3b from the UUI code holding unit 3, the reception counter 1 sends the signal 1b indicative of the completion of the reading to the counter trigger generating unit 11. Thus, the counter trigger generating unit 11 sets the signal 11a into a state indicative of the opening of the trigger state.

By the above operation, the synchronization of the reception packet which takes into consideration the cell delay variation amount after the trigger state can be performed. The generation of the trigger from the read trigger generating unit 10 and the operation of the read control unit 8 will be described in detail in an embodiment 2, which will be explained hereinlater.

<Effects>

As described above, according to the embodiment 1, in case of receiving an arbitrary packet, the trigger state as timing for performing the cell delay variation absorbing process is set by the input of the call setting. Therefore, the synchronization of the reception counter 1 and the discrimination about the normality of the reception packet can be performed without using any special signals.

[Embodiment 2]

According to an embodiment 2, in the trigger state, the packet is read out from the memory 7 at the timing which was elapsed from the write timing of the packet by the time corresponding to the cell delay variation absorption amount, and the packet reading is performed at regular intervals according to the packet time in the states other than the trigger state.

<Construction>

Since a construction on the drawing is similar to that shown in FIG. 1, it will be explained also with reference to FIG. 1.

The read control unit 8 forms read timing from the cell delay variation absorption amount 113 and packet time 114 and sends a signal 8a as a read control signal to the memory 7. The read control unit 8 has a function such that, at the read timing, if the signal 6c indicative of the completion of the writing is not received from the write control unit 6, the signal 8b showing the memory underflow is outputted to the dummy inserting unit 9. The read trigger generating unit 10 has a function for informing the apparatus of the trigger state in response to the signal of the call setting 115 and sends the signal 10a indicative of the trigger state to the read control unit 8.

<Operation>

The embodiment 2 will be described also with reference to FIGS. 9 and 10 mentioned above.

The operations which are executed until the signal 11a indicative of the trigger state is transmitted from the counter trigger generating unit 11 5 by the call setting 115 and the packet of the packet input 110 is stored into the memory 7 on the basis of the signal 11a are similar to those in the embodiment 1.

In the call setting 115, when it is changed to a state where the call has been established, the read trigger generating unit 10 notifies the apparatus of the fact that it entered the trigger state by the signal 10a. The read control unit 8 performs the read control in a manner such that in the case where the trigger state is recognized by the signal 10a of the read trigger generating unit 10, the read timing is formed by using the cell delay variation absorption amount 113, and in the other cases, the read timing is formed by using the packet time 114. If the read timing is formed by using the cell delay variation absorption amount 113, at a start time point of the reading of the packet, the signal 8c serving as a read start signal is sent to the read trigger generating unit 10. The read trigger generating unit 10 which received the signal 8c sets the signal 10a into the opening state of the trigger state at this timing. Therefore, after that, the reading operation is executed by using the packet time 114.

If the signal 6c indicative of the completion of the writing from the write control unit 6 is not received at a point when the read control unit 8 sends the read timing signal 8a, the read control unit 8 sends the signal 8b indicative of the memory underflow to the dummy inserting unit 9. Thus, the dummy inserting unit 9 distributes dummy information in place of the user information.

<Effects>

As described above, according to the embodiment 2, the trigger state is set by the input of the call setting, in this trigger state, the packet reading operation from the memory 7 is performed at the timing which was elapsed by the time corresponding to the cell delay variation absorption amount 113, and in the other cases, it is performed at regular intervals according to the packet time. Therefore, the read control from the memory 7 can be performed without using any special signals.

[Embodiment 3]

According to an embodiment 3, a cell delay variation amount of the packet is measured from an interval between the present time and the arrival time of the next packet.

<Construction>

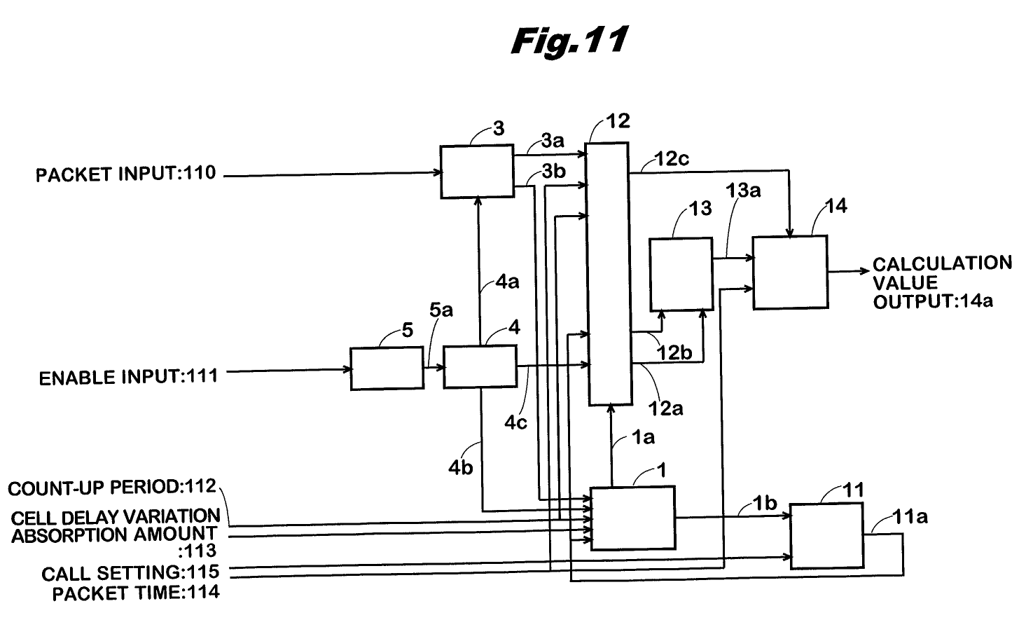

FIG. 11 is a constructional diagram of the embodiment 3.

In the diagram, since a construction in a range from the reception counter 1 to the counter trigger generating unit 11 and the signals in a range from the packet input 110 to the call setting 115 as input signals to the apparatus are similar to those in the construction of FIG. 1, their descriptions are omitted here.

A coincidence loss discriminating unit 12 has a function for detecting a packet loss and a function for discriminating whether the coincidence state continues or not in addition to the function of the coincidence discriminating unit 2 in FIG. 1. Upon detection of the packet loss, the increment period of the UUI code is calculated by the inputs of the count-up period 112 and packet time 114, thereby predicting a UUI code value which will be received next. If the predicted value and the reception value do not coincide, it is regarded as a presence of loss and a signal 12b indicative of it is transmitted. The discrimination about whether the coincidence state continues or not is made because only when it continues, the cell delay variation amount can be calculated for the first time. If the coincidence state continues twice or more times, a signal 12c indicative of a continuous coincidence discrimination result is outputted to a cell delay variation amount calculating unit 14. A signal 12a is a signal showing that the reception UUI code value from the UUI code holding unit 3 and the signal la from the reception counter 1 coincide. If they do not coincide, the signal 12b is used.

Even if the packet loss occurs, there is a possibility that the reception UUI code value and the count value of the reception counter 1 coincide. For example, there is a case where the packet whose UUI code value is equal to 1 reached at the normal timing, the packet whose UUI code value is equal to 2 does not reach, and the packet in which the next UUI code value is equal to 3 reached at the normal timing. In such a case, the signal 12b indicative of the packet loss and the signal 12a as a coincidence signal are simultaneously outputted. To avoid such a situation, when the packet loss is detected, the signal 12a indicative of the coincidence detection result is not transmitted.

A packet time counter 13 is a counter for measuring a receiving interval between the packets and its count-up period conforms with the minimum time at which the cell delay variation amount is measured. The packet time counter 13 is reset by the signal 12a or 12b.

The cell delay variation amount calculating unit 14 has a function for inputting a signal 13a indicative of the count value of the packet time counter 13 and the packet time 114 and fetching a difference between them in response to the signal 12c indicative of the continuous coincidence discrimination result. The fetched value is used as a cell delay variation amount detected from the reception packet.

<Operation>

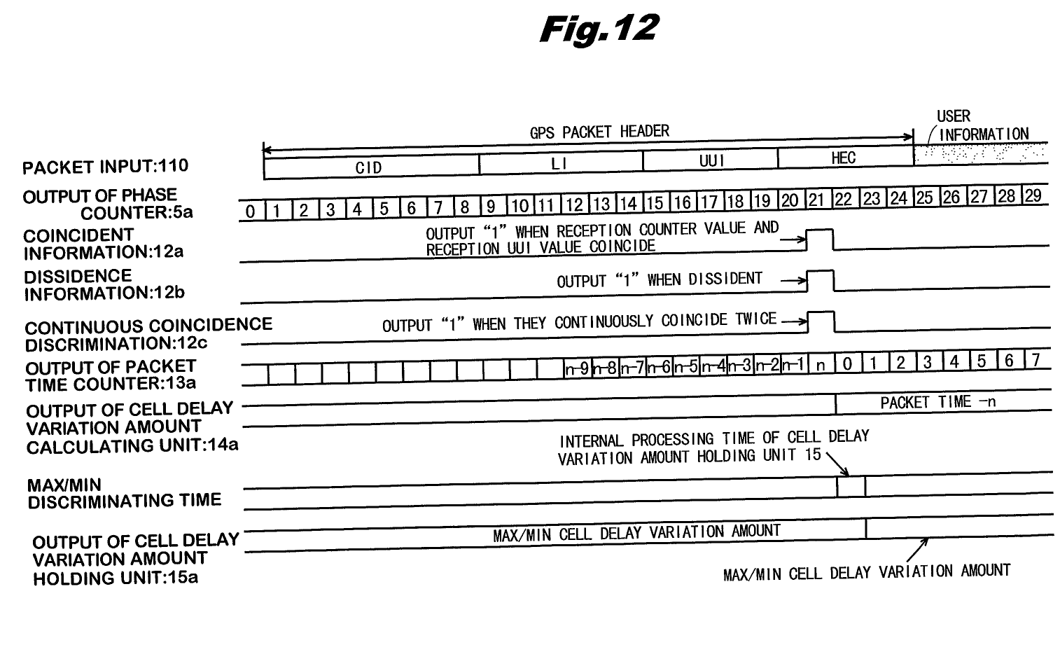

FIG. 12 is a timing chart showing the operation of the embodiment 3.

Since the synchronizing process by the call setting 115 is similar to that in each of the embodiments 1 and 2, only the measuring operation of the cell delay variation amount of the packet will be described.

When the packets continue, the coincidence loss discriminating unit 12 sends “1” as a continuous coincidence discrimination result in the signal 12c. After the packet time counter 13 was reset by “1” by the signal 12a or 12b from the coincidence loss discriminating unit 12, the counter 13 outputs the count value (packet time) of the measurement cell delay variation amount.

When the continuous coincidence discrimination result from the coincidence loss discriminating unit 12 is received, the cell delay variation amount calculating unit 14 sends the packet time from the packet time counter 13 at that time point as a calculation value output 14a of the cell delay variation amount. The holding of the cell delay variation amount will be described in embodiments 4 and 5.

<Effects>

According to the embodiment 3 as mentioned above, besides the constructions of the embodiments 1 and 2, since the cell delay variation amount of the packet is detected, in addition to the effects of the embodiments 1 and 2, there is an effect such that the cell delay variation amount can be further detected.

[Embodiment 4]

According to an embodiment 4, a maximum value of the cell delay variation amount is held in addition to the construction of the embodiment 3.

<Construction>

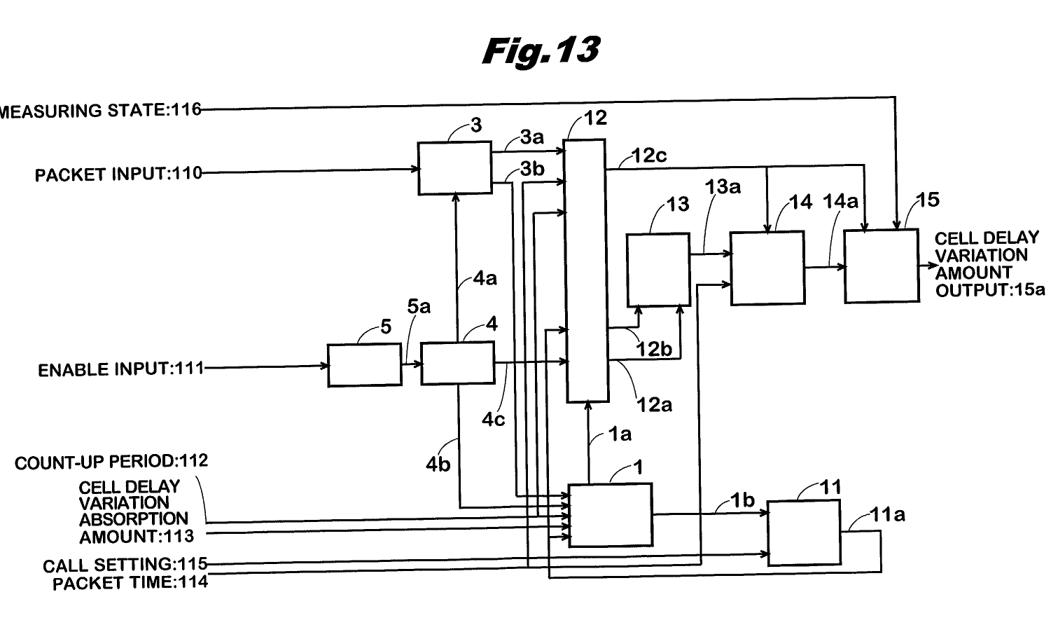

FIG. 13 is a constructional diagram of the embodiment 4.

In the diagram, since the component elements in a range from the reception counter 1 to the cell delay variation amount calculating unit 14 are similar to those in the embodiment 3, their descriptions are omitted here. A cell delay variation amount holding unit 15 is a functional unit for holding the maximum value of the cell delay variation amount in response to the signal 14a of the cell delay variation amount calculating unit 14. The holding operation of the cell delay variation amount holding unit 15 is executed by a measuring state 116. The measuring state 116 is a signal which can be set from the outside, for example, by the user such as a network administrator.

<Operation>

The operation will now be described with reference to the timing chart of FIG. 12.

When the signal indicative of the measuring state is obtained in the measuring state 116 is obtained, the cell delay variation amount holding unit 15 receives the signal 14a of the cell delay variation amount calculating unit 14 and compares the received cell delay variation amount with the previous maximum cell delay variation amount value. When a comparison result indicates that it is larger than the maximum value, it is held as a new maximum value and transmitted as an output 15a of the cell delay variation amount holding unit 15 indicative of the cell delay variation amount. Timing for holding this value is formed on the basis of the signal 12c from the coincidence loss discriminating unit 12. That is, it is the timing when the cell delay variation amount calculating unit 14 calculates the cell delay variation amount.

<Effects>

According to the embodiment 4 as mentioned above, since the maximum value of the cell delay variation amount is held, it is possible to know the maximum value of the cell delay variation amount which the actual network has. There is an effect such that since the network administrator knows the maximum cell delay variation amount, a proper cell delay variation absorption amount can be set on the reception side.

[Embodiment 5]

According to an embodiment 5, the minimum value of the cell delay variation amount is held in addition to the construction of the embodiment 3.

<Construction>

Since a construction on the drawing of the embodiment 5 is similar to that of the embodiment 4 shown in FIG. 13, it will be explained also with reference to FIG. 13.

The cell delay variation amount holding unit 15 in the embodiment 5 has a function for holding the minimum value of the cell delay variation amount depending on the measuring state 116. Other constructions are similar to those of the embodiment 4.

<Operation>

The operation will now be described also with reference to the timing chart of FIG. 12.

When a state to instruct the measurement is obtained by the measuring state 116, the cell delay variation amount holding unit 15 receives the signal 14a of the cell delay variation amount calculating unit 14 and compares the reception cell delay variation amount with the previous minimum cell delay variation amount value. When a comparison result indicates that it is smalller than the minimum value, it is held as a new minimum value and outputted as an output 15a of the cell delay variation amount holding unit 15. Timing for holding this value is formed on the basis of the signal 12c from the coincidence loss discriminating unit 12. That is, it is the timing when the cell delay variation amount calculating unit 14 calculates the cell delay variation amount.

<Effects>

According to the embodiment 5 as mentioned above, since the minimum value of the cell delay variation amount is held, it is possible to know the minimum value of the cell delay variation amount which the actual network has. There is an effect such that since the network administrator knows the minimum cell delay variation amount, a proper cell delay variation absorption amount can be set on the reception side.

[Embodiment 6]

According to an embodiment 6, in an apparatus in the transmitting direction, a test packet of the cell delay variation amount is formed in a state where the user packet is not communicated and the test packet is transmitted at regular intervals.

<Construction>

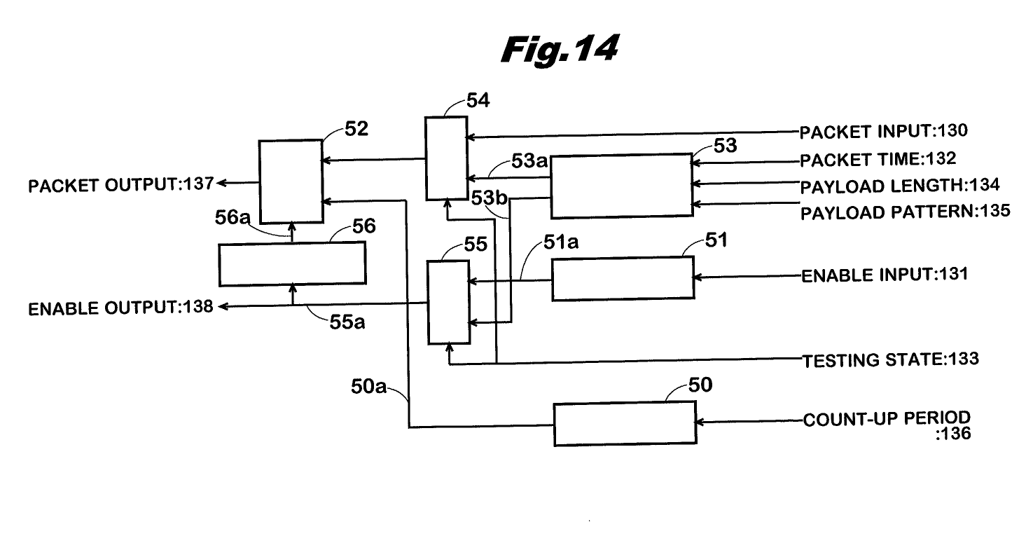

FIG. 14 is a constructional diagram of the embodiment 6.

An apparatus shown in the diagram comprises: a transmission counter 50; a header area setting unit 51; a UUI selector 52; a test packet forming unit 53; selectors 54 and 55; and a UUI timing forming unit 56. A packet input 130 is supplied to the selector 54. An enable input 131 is supplied to the header area setting unit 51. A packet time 132, a payload length 134, and a payload pattern 135 are inputted to the test packet forming unit 53. A testing state 133 is inputted to the selectors 54 and 55. A count-up period 136 is inputted to the transmission counter 50.

The transmission counter 50 is an up-counter of 4 bits which operates in accordance with the count-up period 136 from timing of turn-on of a power source. A signal 50a of the transmission counter 50 is sent to the UUI selector 52. The header area setting unit 51 is a functional unit for adding an enable area of 3 bytes to the head of an enable signal sent from the enable input 131 and holding the area of the CPS header. A signal 51a of the header area setting unit 51 is supplied to the selector 55. The UUI selector 52 has a function for inserting a value of the signal 50a of the transmission counter 50 into LSB 4 bits of a UUI field of the packet in response to a timing signal generated by the UUI timing forming unit 56 and sending it as a packet output 137. The MSB bit is fixed to “0” in this instance.

The test packet forming unit 53 has a function for forming a packet constructed by predetermined payload length and payload pattern and sending it as a signal 53a to the selector 54 in accordance with the packet time 132.

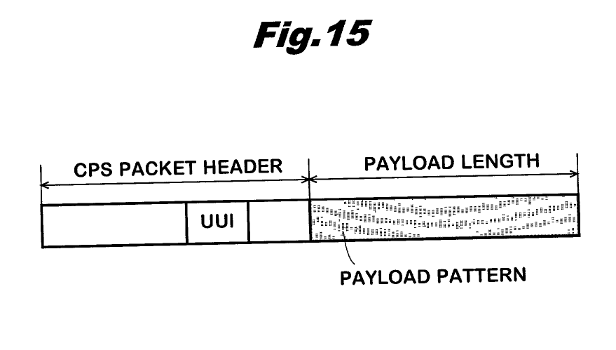

FIG. 15 is an explanatory diagram showing a format of the formed test packet.

Although the formation of the packet is performed by the payload length 134 and payload pattern 135 which are supplied from the outside, these payloads are not always necessary in the embodiment. However, in the ITU-T I.363.2, although it has been standardized that the length of payload is shown in an LI (Length Indicator) field in the CPS header, a method of showing a state of the payload length of “0” is not shown. Therefore, the construction for adding an arbitrary payload is purposely used. The test packet forming unit 53 also forms an enable signal synchronized with the signal of the test packet and sends it as a signal 53b to the selector 55.

The selectors 54 and 55 are switched in dependence on the presence or absence of the testing state 133. When a cell delay variation amount test is not performed, the packet input 130 and the signal 51a of the header area setting unit 51 are selected. When the test is performed, the signals 53a and 53b of the test packet forming unit 53 are selected.

The UUI timing forming unit 56 forms timing for allowing the UUI selector 52 to insert the count value of the transmission counter 50 on the basis of a signal 55a of the selector 55.

<Operation>

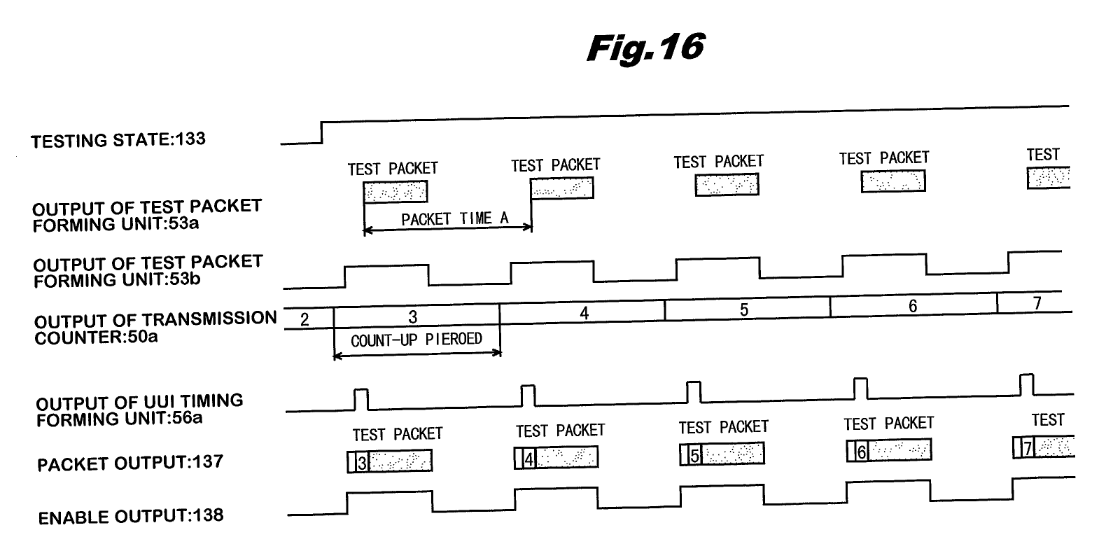

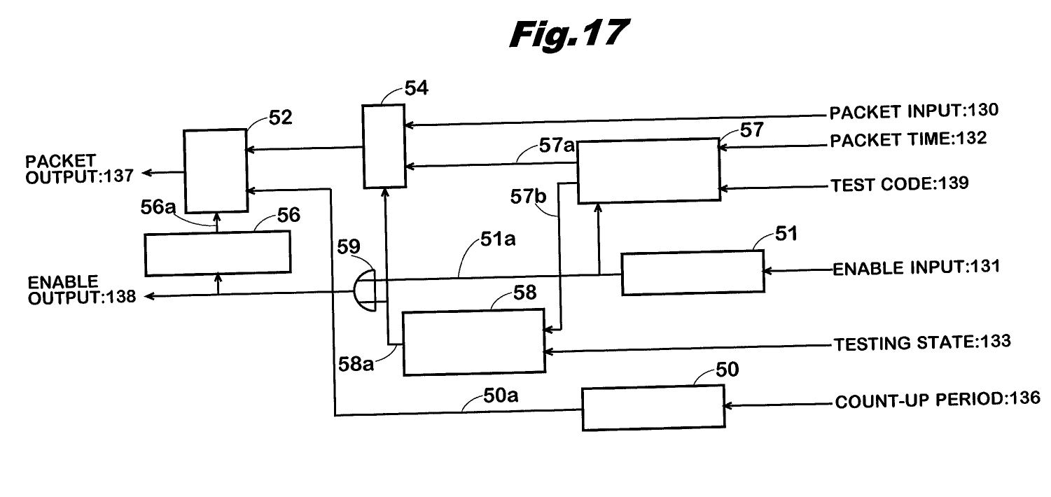

FIG. 16 is a timing chart showing the operation of the embodiment 6.

In the packet input 130, the user information is inputted in a state where it has been mapped to the Type1 packet. In the enable input 131, the enable signal indicative of its phase is inputted. The header area setting unit 51 adds an enable area of 3 bytes to the head of the inputted enable signal and sends the signal 51a to the selector 55.

Upon normal transmission in which no test is performed, each of the selectors 54 and 55 selects the packet input 130 and the signal 51a of the header area setting unit 51. On the basis of those signals, the UUI selector 52 inserts the count value of the transmission counter 50 into the LSB 4 bits of the UUI field of the packet and sends a resultant value as a packet output 137. Since the above operations are similar to those in the conventional apparatus, they are not shown in FIG. 16.

When the signal of the testing state 133 is equal to “1”, the selectors 54 and 55 select the signals 53a and 53b of the test packet forming unit 53, respectively. Thus, the test packet similar to the user information is transmitted from the selector 54 and an enable output 138 corresponding to the test packet forming timing is transmitted from the selector 55. The UUI selector 52 inserts the count value of the transmission counter 50 into the LSB 4 bits of the UUI field of the test packet and sends a resultant value as a packet output 137 in response to the timing signal generated from the UUI timing forming unit 56. In this instance, the MSB bit is fixed to “0” as mentioned above.

<Effects>

According to the embodiment 6 as mentioned above, since the apparatus in the transmitting direction has the function for forming the test packet for the cell delay variation amount, there is an effect such that even in the case where the user information does not exist during the construction of the network, the cell delay variation amount can be measured.

[Embodiment 7]

According to an embodiment 7, in an apparatus in the transmitting direction, a test packet of the cell delay variation amount is formed and transmitted at timing when no user packet exists.

<Construction>

FIG. 17 is a constructional diagram of the embodiment 7.

An apparatus shown in the diagram comprises: the transmission counter 50; the header area setting unit 51; the UUI selector 52; the selector 54; the UUI timing forming unit 56; a test packet forming unit 57; a test timing forming unit 58; and an OR circuit 59. The packet input 130 is supplied to the selector 54. The enable input 131 is supplied to the header area setting unit 51. The packet time 132 and a test code 139 are inputted to the test packet forming unit 57. The testing state 133 is inputted to the test timing forming unit 58. The count-up period 136 is inputted to the transmission counter 50. Since a construction in a range from the transmission counter 50 to the UUI timing forming unit 56 is similar to that in the embodiment 6, its description is omitted here.

The test packet forming unit 57 forms the following test packet in accordance with the packet time 132.

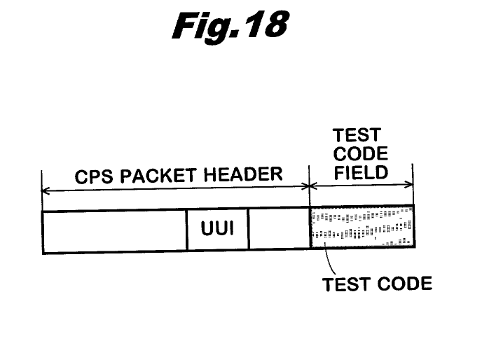

FIG. 18 is an explanatory diagram of the test packet.

In this instance, to prevent the forming timing from being overlapped with the user packet, the enable signal from the header area setting unit 51 is received and the test packet is formed when the enable signal is in a disable state. The test packet forming unit 57 forms the enable signal synchronized with a signal 57b of the test packet and transmits it as a signal 57a to the selector 54. The test timing forming unit 58 is a functional unit for allowing the enable signal to pass only at the time of the testing state by receiving the signal 57b indicative of “enable” from the test packet forming unit 57 and by receiving the testing state 133. The OR circuit 59 is a circuit for performing an OR arithmetic operation of the enable signal of the header area setting unit 51 and a signal 58a of the test timing forming unit 58. The selector 54 switches the user packet and the test packet in response to the signal 58a of the test timing forming unit 58.

<Operation>

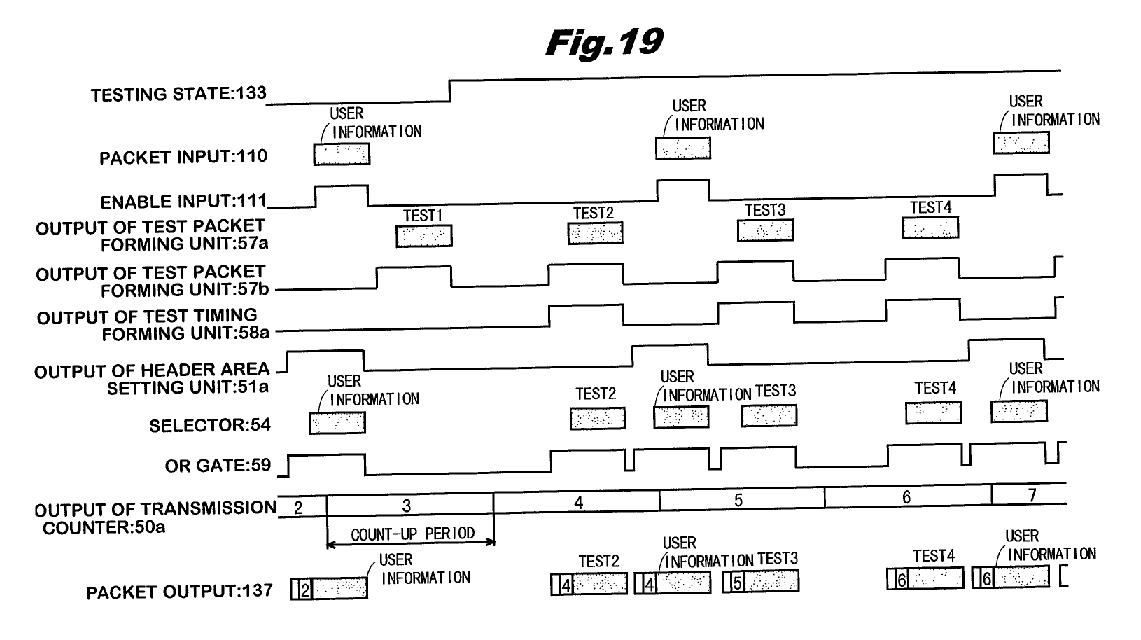

FIG. 19 is a timing chart showing the operation of the embodiment 7.

Upon normal transmission, the selector 54 selects the packet input 130 and the enable signal of the header area setting unit 51 is sent as an enable output 138 through the OR circuit 59. The user information is supplied from the selector 54 to the UUI selector 52. The UUI selector 52 inserts the count value of the transmission counter 50 into the LSB 4 bits of the UUI field of the CPS packet header and sends a resultant value as a packet output 137. The MSB bit is fixed to “0” in this instance in a manner similar to the embodiment 6.

When the signal of the testing state 133 is equal to “1”, the test packet forming unit 57 forms the test packet as shown in FIG. 18 in response to the packet input 130. However, if the signal 51a from the header area setting unit 51 indicates the enable state, the test packet forming unit 57 does not form the test packet, but forms it when the signal 51a indicates the disable state. The value instructed by the test code 139 is inputted into the test code field which the test packet has. When the signal 57a indicative of the formation of the test packet is sent to the selector 54, the test packet forming unit 57 sends the signal 57b as an enable signal to the test timing forming unit 58.

The test timing forming unit 58 receives the signal 57b as an enable signal of the test packet from the test packet forming unit 57 and allows the signal 57b to pass only when the testing state 133 indicates the testing state. When the signal 58a from the test timing forming unit 58 is received, the selector 54 selects the signal 57a of the test packet forming unit 57 and sends it to the UUI selector 52. The signal 58a from the test timing forming unit 58 is supplied to the UUI timing forming unit 56 through the OR circuit 59. The UUI selector 52 inserts the count value of the transmission counter 50 into the LSB 4 bits of the UUI field of the CPS packet header at that timing and sends a resultant value as a packet output 137. As mentioned above, the test packet is sent only when no user packet exists and is in the testing state.

<Effects>

According to the embodiment 7 as mentioned above, since the test code field is provided for the test packet and the test packet is inserted into an interval of the user packets, there is an effect such that the cell delay variation amount can be measured irrespective of the presence or absence of the user packet.

[Embodiment 8]

According to an embodiment 8, in an apparatus in the receiving direction, when the test packet is received, it is recognized that it is the test packet on the basis of the test code included in the packet.

<Construction>

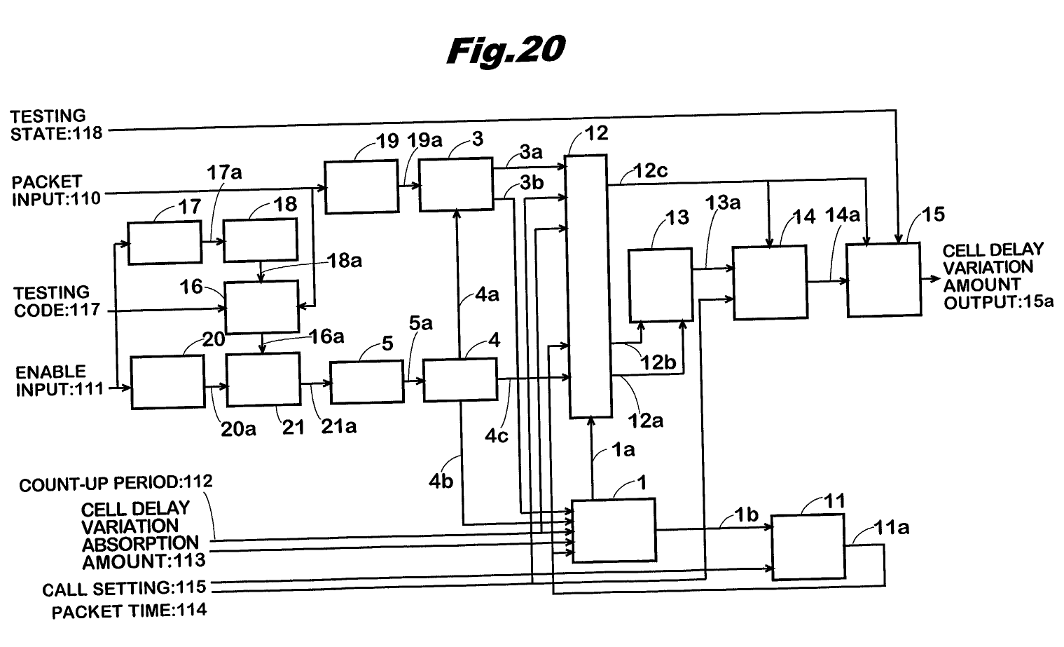

FIG. 20 is a constructional diagram of the embodiment 8.

In the diagram, since a construction in a range from the reception counter 1 to the cell delay variation amount holding unit 15 is similar to that of the embodiment 4 shown in FIG. 13, its description is omitted here.

A test code detecting unit 16 has a function for extracting the test code from the reception packet by using a signal decoded by a test decoding unit 18, discriminating about a coincidence between the extracted test code and a test code 117, and sending a discrimination result as a signal 16a to an enable forming unit 21.

A test phase counter 17 is a counter which counts up in response to the signal of the enable input 111. That is, since the signal of the enable input 111 is supplied synchronously with the phase of the packet input 110, a signal 17a of the test phase counter 17 is transmitted synchronously with the phase of the reception packet.

The test decoding unit 18 forms a signal for extracting the test code from the reception packet in response to the signal 17a of the test phase counter 17 and sends such a signal 18a to the test code detecting unit 16.

A packet delay unit 19 is a functional unit for executing a delaying process of 32 bits to the reception packet of the packet input 110. An enable delay unit 20 is a functional unit for executing a delaying process of 32 bits to the reception enable signal of the enable input 111. Those delay units are provided for matching the timing with the test packet discrimination timing in the test code detecting unit 16.

The enable forming unit 21 is a functional unit for executing a process for allowing a delay signal 20a of the enable delay unit 20 to pass as it is or stopping the signal. The signal is allowed to pass in the case where a discrimination result shown by the signal 16a of the test code detecting unit 16 indicates the coincidence, that is, when it is determined that the reception packet is the test packet.

The test code 117 is inputted to the test code detecting unit 16.

The enable input 111 is supplied to the test phase counter 17 and enable delay unit 20. The packet input 110 is supplied to the packet delay unit 19. A testing state 118 is inputted to the cell delay variation amount holding unit 15. The testing state 118 is a signal which can be set from the outside and is a signal which is set by, for example, the user such as a network administrator.

<Operation>

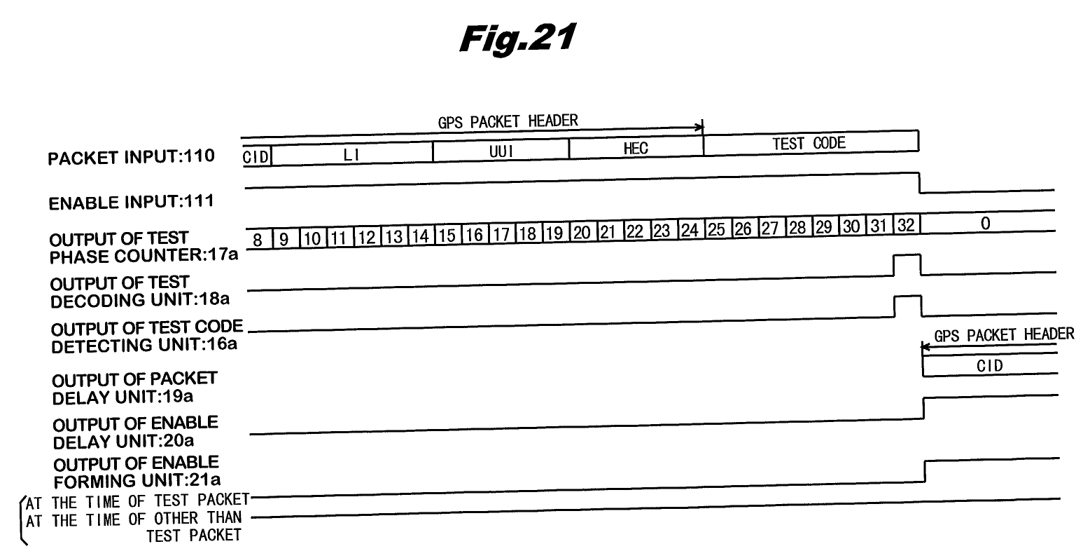

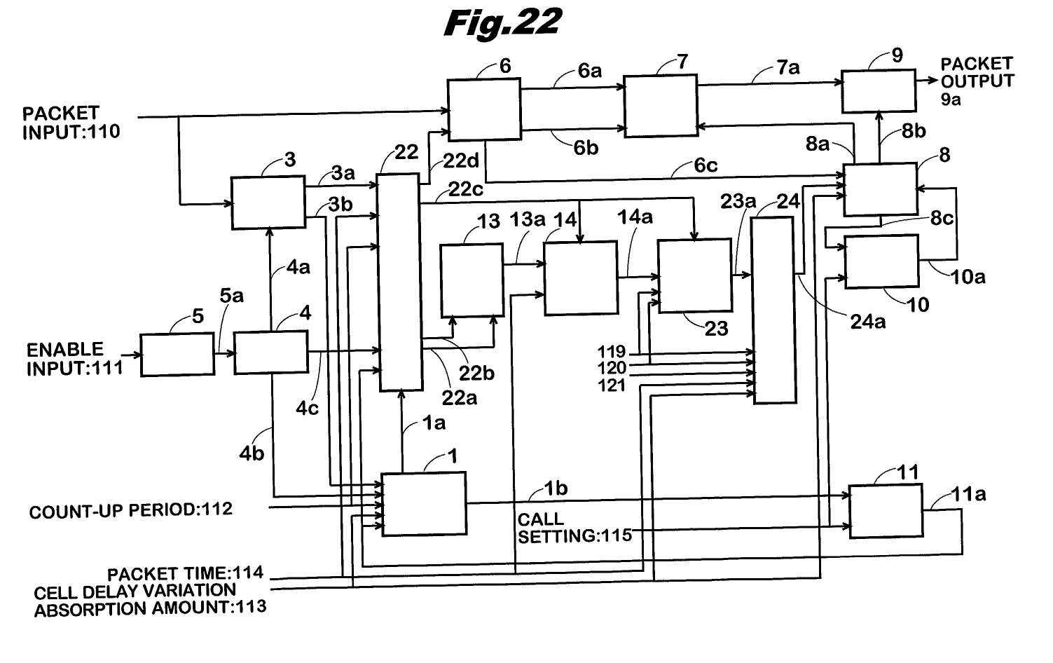

FIG. 21 is a timing chart showing the operation of the embodiment 8.

When the enable input 111 corresponding to the packet input 110 is supplied to the test phase counter 17, the test phase counter 17 counts up.

The test decoding unit 18 forms the signal for extracting the test code in response to the signal 17a. Since the test code which has been predetermined from the outside is inputted as a test code 117, the test code detecting unit 16 discriminates about a coincidence between the predetermined test code and the test code extracted from the packet of the packet input 110.

If it is determined that it is the test packet by the test code detecting unit 16, the enable forming unit 21 allows the enable signal delayed by the enable delay unit 20 to pass as it is. The packet input 110 is delayed for a time corresponding to 32 bits by the packet delay unit 19 and sent to the UUI code holding unit 3. Thus, the timing of the packet which is inputted to the UUI code holding unit 3 and that of the enable signal which is inputted to the phase counter 5 coincide.

Subsequent processes of the packets are similar to those in the embodiment 4 and, when the signal of the testing state 118 is inputted, the cell delay variation amount holding unit 15 measures the maximum cell delay variation amount and minimum cell delay variation amount during the test.

<Effects>

According to the embodiment 8 as mentioned above, since the test code field is provided for the test packet and the means for discriminating the test packet and the user packet is provided for the apparatus on the reception side, there is an effect such that the user packet and the test packet can be distinguished and the cell delay variation amount can be measured irrespective of the presence or absence of the user packet. There is an effect such that by making the cell delay variation amount holding unit 15 operative by the signal of the testing state 118, the maximum cell delay variation amount and minimum cell delay variation amount during the execution of the test can be measured.

[Embodiment 9]

According to an embodiment 9, in an apparatus in the receiving direction, an automatic adjusting interval is provided, the maximum cell delay variation absorption amount is measured in this interval, and the cell delay variation absorption amount is adjusted on the basis of it.

<Construction>

FIG. 22 is a constructional diagram of the embodiment 9.

In the diagram, since a construction in a range from the reception counter 1 to the counter trigger generating unit 11 is similar to that of the embodiment 1 shown in FIG. 1 and the packet time counter 13 and cell delay variation amount calculating unit 14 are similar to those in the embodiment 3 shown in FIG. 11, their descriptions are omitted here.

A reception discriminating unit 22 has both of the functions of the coincidence discriminating unit 2 in the embodiment 1 and the coincidence loss discriminating unit 12 in the embodiment 3 and generates a signal 22a indicative of coincidence information, a signal 22b indicative of dissidence loss information, a signal 22c indicative of continuous coincidence information, and a signal 22d indicative of dissidence information. The signal 22a of the coincidence information, the signal 22b of the dissidence loss information, and the signal 22c of the continuous coincidence information are similar to the signals 12a, 12b, and 12c in the embodiment 3. The signal 22d of the dissidence information is a signal showing that the UUI code of the reception packet and the count value of the reception counter 1 do not coincide.

Although an interval cell delay variation amount holding unit 23 is a functional unit for executing almost the same process as that of the cell delay variation amount holding unit 15 in FIG. 13, there is a difference with respect to a point that when an input of an automatic adjusting state 120 is active, the holding unit 23 holds the maximum cell delay variation amount of each interval unit shown by an automatic adjusting interval 119 and outputs it.

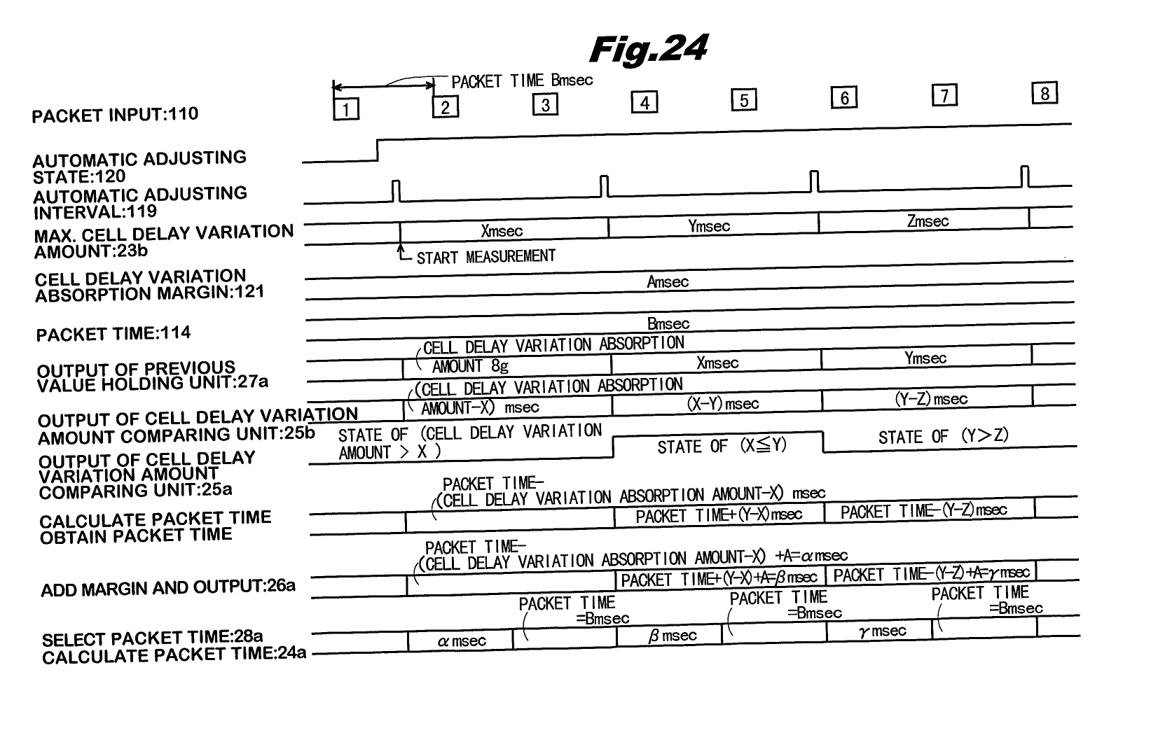

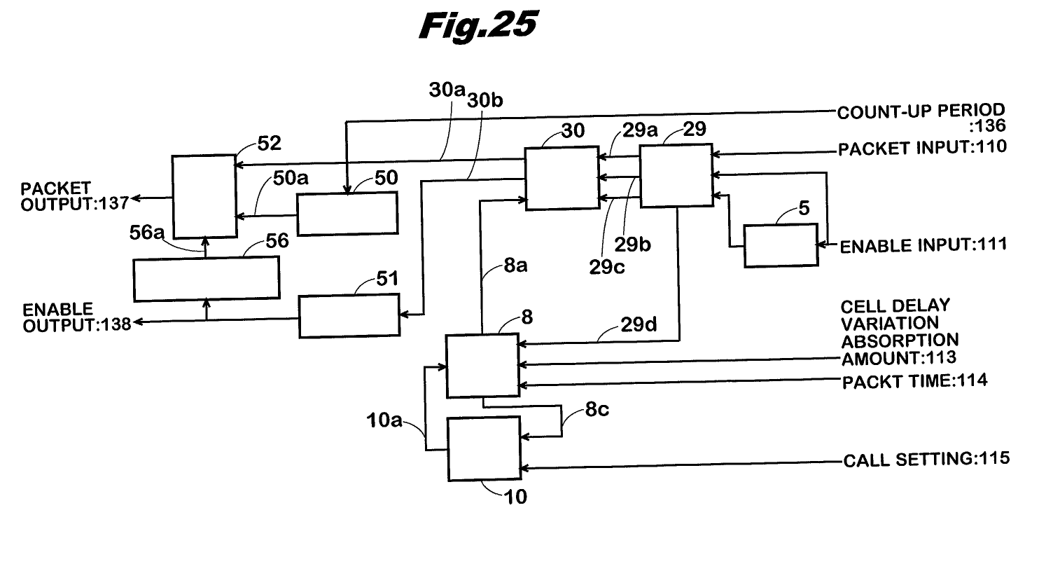

A packet time calculating unit 24 is a functional unit for making an automatic adjustment of the packet time on the basis of the maximum cell delay variation amount held in the interval cell delay variation amount holding unit 23 in case of the automatic adjusting state. The packet time calculating unit 24 receives: a signal 23a from the interval cell delay variation amount holding unit 23; the automatic adjusting interval 119; the automatic adjusting state 120; a cell delay variation absorption margin 121; the cell delay variation absorption amount 113; and the packet time 114. As shown in FIG. 24, which will be explained hereinlater, the automatic adjusting interval 119 is a signal indicative of timing of (packet time x n). The automatic adjusting state 120 is a signal to designate the automatic adjusting state which is inputted by the network administrator or the like. The cell delay variation absorption margin 121 is a time for cell delay variation absorption which has previously been given.

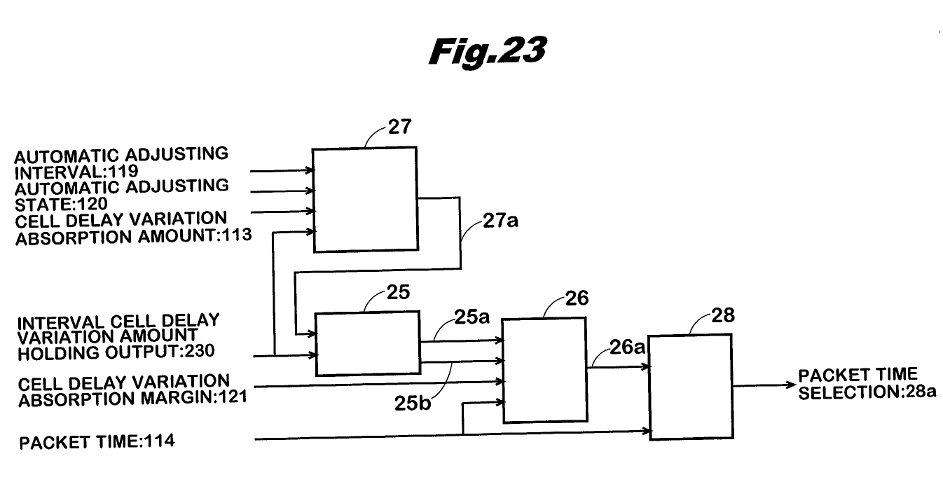

FIG. 23 is an internal constructional diagram of the packet time calculating unit 24.

As shown in the diagram, the packet time calculating unit 24 comprises a cell delay variation amount comparing unit 25, a packet time calculating unit 26, a previous value holding unit 27, and a packet time selecting unit 28.

The cell delay variation amount comparing unit 25 is a functional unit for receiving the maximum cell delay variation amount (the signal 23a of the interval cell delay variation amount holding unit 23) of each automatic adjusting interval, comparing it with the cell delay variation amount of the previous interval (the signal 27a of the previous value holding unit 27), outputting a difference between them as a signal 25b to the packet time calculating unit 26, and sending a result indicating which one of the inputs has a large value as a signal 25a. The packet time calculating unit 26 is a functional unit which is constructed in a manner such that the signals 25a and 25b from the cell delay variation amount comparing unit 25 are received, if the state of the signal 25a indicates that the interval cell delay variation amount is larger than the previous value, a value obtained by adding the cell delay variation absorption margin 121 to a value obtained by adding a difference between them to the value of the packet timer 114 is sent as a signal 26a indicative of a packet time calculation result to the packet time selecting unit 28, and when the state of the signal 25a indicates that the interval cell delay variation amount is smaller than the previous value, a value obtained by adding the cell delay variation absorption margin 121 to a value obtained by subtracting the difference from the value of the packet time 114 is sent as a signal 26a indicative of the packet time calculation result to the packet time selecting unit 28.

The previous value holding unit 27 has a function for holding the signal 23a of the interval cell delay variation amount holding unit 23 in response to the signal of the automatic adjusting interval 119 when the automatic adjusting state 120 is active. In the first interval after the automatic adjusting state was obtained, the value of the cell delay variation absorption amount 113 is held instead of the value of the signal 23a.

The packet time selecting unit 28 is a functional unit for inputting the signal 26a of the packet time calculating unit 26 and the packet time 114, selecting the signal 26a for an interval of the first packet time in each interval of the automatic adjusting interval, selecting the packet time 114 in the other intervals, and using it as a signal 28a indicative of the packet time selection result.

<Operation>

FIG. 24 is a timing chart showing the operation of the embodiment 9.

First, the operation in each unit up to the cell delay variation amount calculating process in the cell delay variation amount calculating unit 14, the packet storing process into the memory 7 by the write control unit 6, and the reading process by the read control unit 8 are similar to those in the embodiments 1 and 3. The reception discriminating unit 22 operates in a manner similar to the coincidence discriminating unit 2 in the embodiment 1 and the coincidence loss discriminating unit 12 in the embodiment 3.

When the automatic adjusting state 120 is active, the interval cell delay variation amount holding unit 23 holds the maximum cell delay variation amount of each interval unit shown by the automatic adjusting interval 119 and sends it as a signal 23a to the packet time calculating unit 24.

In the embodiment, the automatic adjusting interval 119 is set to (packet time×2) as shown in the diagram.

When the automatic adjusting state 120 is active, the packet time calculating unit 24 executes the following process. The previous value holding unit 27 holds the signal 23a from the interval cell delay variation amount holding unit 23 in accordance with the automatic adjusting interval 119 and sends it as a signal 27a to the cell delay variation amount comparing unit 25. In the first interval after the automatic adjusting state 120 was made active, the value of the cell delay variation absorption amount 113 is held.

The cell delay variation amount comparing unit 25 compares the value of the signal 23a of the interval cell delay variation amount holding unit 23 with that of the signal 27a of the previous value holding unit 27, thereby obtaining a magnitude relation and a difference between them. If the signal 27a>the signal 23a, that is, when the previous cell delay variation amount is larger than the present cell delay variation amount, the signal 25a indicative of the magnitude relation is set to “0”. If the signal 27a<the signal 23a, the signal 25a is set to “1”. A difference value between the signal 27a and signal 23a is sent as a signal 25b to the packet time calculating unit 26.

When the signal 25a from the cell delay variation amount comparing unit 25 is equal to “0”, the packet time calculating unit 26 outputs [the packet time−difference value (signal 25b)+cell delay variation absorption margin] as a packet time. When the signal 25a from the cell delay variation amount comparing unit 25 is equal to “1”, the packet time calculating unit 26 outputs [the packet time+difference value (signal 25b)+cell delay variation absorption margin] as a packet time.

The packet time selecting unit 28 selects the signal 26a of the packet time calculating unit 26 for an interval (n=1) of the first packet time in each interval of the automatic adjusting interval, selects the packet time in the other intervals (n=2 to n: in case of the embodiment, n=2), and outputs the selected one as a signal 28a indicative of a packet time selection result.

In the read control unit 8, usually, with respect to the distribution packets (signal 8a) read out at regular intervals, the difference of the cell delay variation amount is added or subtracted to/from the packet time once in a range shown by the automatic adjusting interval 119 in accordance with the packet time 114, thereby changing the distributing time and automatically adjusting the cell delay variation.

<Effects>

According to the embodiment 9 as mentioned above, since the difference of the cell delay variation amount is added or subtracted to/from the packet time, the proper cell delay variation absorption can be automatically performed and there is an effect such that the network administrator can perform the cell delay variation absorption according to the situation without being aware of it.

[Embodiment 10]

According to an embodiment 10, in an apparatus in the transmitting direction, a cell delay variation which was caused on the user side is absorbed.

<Construction>

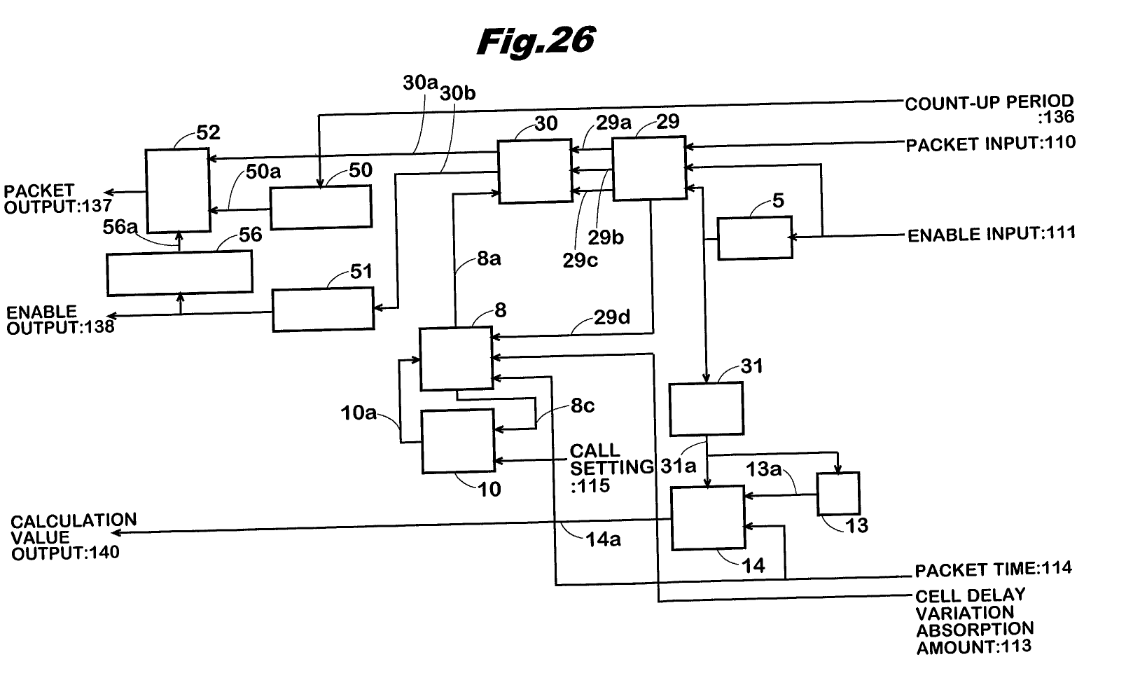

FIG. 25 is a constructional diagram of the embodiment 10.

An apparatus shown in the diagram comprises: the phase counter 5; the read control unit 8; the read trigger generating unit 10; a write control unit 29; a memory 30; the transmission counter 50; the header area setting unit 51; the UUI selector 52; and the UUI timing forming unit 56. In the embodiment, the cell delay variation absorbing function is provided in the transmitting direction. It differs from the cell delay variation absorption in the receiving direction in each of the embodiments 1 to 5, 8, 9, and the like described above. The above cell delay variation absorbing function is not provided to absorb a cell delay variation which was caused in the ATM network or on the user side who assembles the ATM cells but is provided to absorb a cell delay variation which was caused on the user side who assembles the packets. Therefore, there is no need to consider the cell loss as in case of transmitting the data on the ATM network and the detecting function of the cell loss using the UUI code and the dummy inserting function do not exist.

The timing for reading out the data from the memory 7 is formed from the cell delay variation absorption amount at the time of the trigger state and formed from the packet time in the other cases, and has a construction similar to the function on the reception side. That is, the phase counter 5, read control unit 8, and read trigger generating unit 10 are similar to those in the embodiments 1 and 2 shown in FIG. 1. The write control unit 29 makes a timing adjustment for writing the packet input 110 and enable input 111 into the memory 30, outputs them as signals 29a and 29b to the memory 30, forms a write control signal 29c, and sends it to the memory 30. The write control unit 29 notifies the read control unit 8 of the completion of the writing of the packet by a signal 29d. The memory 30 outputs a signal 30a of the packets accumulated in the memory 30 and an enable signal 30b in response to the read control signal 8a from the read control unit 8.

A construction in a range from the transmission counter 50 to the UUI timing generating unit 56 is similar to that in the embodiment 6 shown in FIG. 14. Further, the packet input 110, enable input 111, cell delay variation absorption amount 113, packet time 114, and call setting 115 are the signals corresponding to those in a range from the packet input 110 to the call setting 115 in the embodiments 1 to 5, 8, 9, and the like.

<Operation>

The operation of the embodiment 10 will now be described with reference to FIGS. 9, 10, and 16.

The operations of the component elements in a range from the phase counter 5 to the read trigger generating unit 10 are similar to those of the component elements in a range from the phase counter 5 to the read trigger generating unit 10 in the embodiments 1 and 2. That is, the operations of the embodiment are similar to those of the portion of the call setting 115, packet input 110, enable input 111, and phase counter output 5a in FIG. 9 and those of the portion of the call setting 115, packet input 110, enable input 111, write control unit output signal 6a, read start signal 8c, read trigger generating unit output 10a, and packet output 9a. In the embodiment, however, the packet output 9a becomes the signal 30a from the memory 30 and no dummy packet is transmitted.

The operations of the component elements in a range from the range from the transmission counter 50 to the UUI timing generating unit 56 is similar to those of the component elements in a range from the transmission counter 50 to the UUI timing generating unit 56 in FIG. 14. In the embodiment, the inputs to the UUI selector 52 and header area setting unit 51 in FIG. 14 are the signals 30a and 30b from the memory 30, respectively. In the timing chart of FIG. 16, those operations correspond to the transmission counter signal 50a, UUI timing generating unit output 56a, packet output 137, and enable output 138. Either the test packet or the user packet can be used as a packet as a target in the embodiment.

<Effects>

According to the embodiment 10 as mentioned above, since the memory for absorbing the cell delay variation is provided on the transmission side and the trigger state is provided, there is an effect such that the cell delay variation which was caused upon formation of the packet on the user side is absorbed in the trigger state and the signal according to the packet time is used in the cases other than the trigger state.

[Embodiment 11]

According to an embodiment 11, in an apparatus in the transmitting direction, an amount of cell delay variation which was caused on the user side is measured.

<Construction>

FIG. 26 is a constructional diagram of an embodiment 11.

In the diagram, a construction of the phase counter 5, read control unit 8, read trigger generating unit 10, write control unit 29, and memory 30, 5 and a construction in a range from the transmission counter 50 to the UUI timing forming unit 56 are similar to those in the embodiment 10 mentioned above. The packet time counter 13 and cell delay variation amount calculating unit 14 are similar to those in the embodiment 3 shown in FIG. 11. Further, a decoding unit 31 has a function for transmitting a signal 31a having timing similar to the signal 12a (coincidence information 12a in FIG. 12) of the coincidence loss discriminating unit 12 in the embodiment 3 to the cell delay variation amount calculating unit 14. That is, the embodiment 11 is obtained by adding the packet time counter 13, cell delay variation amount calculating unit 14, and decoding unit 31 to the construction of the embodiment 10.

According to the embodiment, in the transmitting direction, an amount of cell delay variation which was caused when the packets are assembled is measured. Therefore, unlike the receiving direction processes, there is no need to consider a cell loss such as a loss which was caused when the ATM network is transmitted and the apparatus does not have the function for detecting the cell loss using the UUI code.

The packet time counter 13 is a counter for measuring a receiving interval between the packets. Its count-up period conforms with the minimum time which is necessary for measuring the cell delay variation amount. This counter is reset by the signal of the decoding unit 31.

The cell delay variation amount calculating unit 14 receives the signal 13a of the packet time counter 13 and the packet time 114, fetches a difference between them in response to the signal of the decoding unit 31, and sets the fetched value to a calculation value output 140 indicative of the cell delay variation amount detected from the transmission packet.

<Operation>

The operation of the embodiment 11 will now be described also with reference to FIG. 12.

Since the operations of the phase counter 5 to the read trigger generating unit 10, the write control unit 29, memory 30, and the transmission counter 50 to the UUI timing forming unit 56 are similar to those in the embodiment 10, their descriptions are omitted here.

The packet time counter 13 outputs the count value to the cell delay variation amount calculating unit 14 at a predetermined count-up period. The packet time 114 is inputted to the cell delay variation amount calculating unit 14. At timing when the signal from the decoding unit 31 is equal to “1”, the cell delay variation amount calculating unit 14 calculates a difference between the value of the signal 13a from the packet time counter 13 and the packet time 114 and sends it as a calculation value signal 14a of the cell delay variation amount. Those operations correspond to the packet input 110, phase counter output 5a, coincidence information 12a, packet time counter output 13a, and cell delay variation amount calculating unit output 14a in FIG. 12.

<Effects>

According to the embodiment 11 as mentioned above, besides the effects of the embodiment 10, since the receiving time interval between the packets is measured and the packet time is compared, there is an effect such that the cell delay variation amount in the packet which is inputted from the user can be measured.

[Embodiment 12]

According to an embodiment 12, in an apparatus in the transmitting direction, a maximum amount of cell delay variation which was caused on the user side is measured.

<Construction>

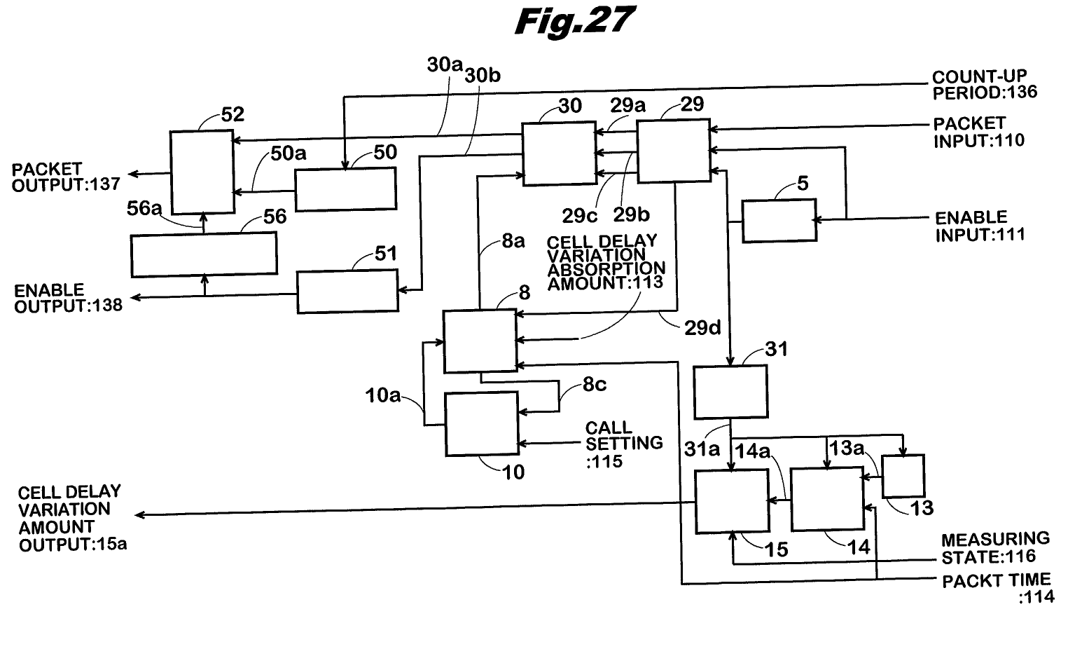

FIG. 27 is a constructional diagram of an embodiment 12.

In the diagram, a construction other than the cell delay variation amount holding unit 15, the measuring state 116 which is inputted thereto, and the signal 15a is similar to that in the embodiment 11, its description is omitted here. The cell delay variation amount holding unit 15 has a construction similar to that of the cell delay variation amount holding unit 15 in the embodiment 4 shown in FIG. 13 and is a functional unit for holding the maximum cell delay variation amount. That is, the cell delay variation amount holding unit 15 has a function for holding the maximum value of the calculation value from the cell delay variation amount calculating unit 14 at the timing of the signal 31a from the decoding unit 31. The measuring state 116 is measuring state designating means which can be arbitrarily designated from the outside, is a signal which is designated by the network administrator or the like, and is a signal which indicates, for example, the measuring state by “1” and the non-measuring state by “0”.

<Operation>

The operation of the embodiment 11 will now be described hereinbelow also with reference to FIG. 12.

According to the embodiment, since the process in the transmitting direction is executed, there is no need to consider the cell loss as in case of transmitting the data on the ATM network as in the receiving direction and the UUI code is certainly continuously transmitted, so that the continuous coincidence discrimination of the UUI code is not performed.

First, since the operations which are executed up to the calculation of the cell delay variation amount by the cell delay variation amount calculating unit 14 are similar to those in the embodiment 11, their descriptions are omitted.

When the measuring state 116 is equal to “1”, the cell delay variation amount holding unit 15 receives the signal 14a of the cell delay variation amount calculating unit 14 and compares the reception cell delay variation amount with the value of the previous maximum cell delay variation amount. When a comparison result indicates that it is larger than the maximum value, it is held as a new maximum value and sent as a signal 15a. Those operations correspond to the packet input 110, phase counter 5, coincidence information 12a, packet time counter output 13a, cell delay variation amount calculating unit output 14a, maximum/minimum discriminating times, and cell delay variation amount holding unit output 15a in FIG. 12. When the measuring state 116 is equal to “0”, the cell delay variation amount holding unit 15 stops the holding.

<Effects>

As mentioned above, according to the embodiment 12, in addition to the construction of the embodiment 11, since the measuring state 116 is inputted and the maximum cell delay variation amount within the measuring time is held, the maximum value of the cell delay variation amount on the user side can be known. There is an effect such that since the network administrator knows the maximum cell delay variation amount, the proper cell delay variation absorption amount can be set on the transmission side.

[Embodiment 13]

According to an embodiment 13, a minimum amount of cell delay variation which was caused on the user side is measured in the transmitting direction.

<Construction>

In the embodiment 13, since a construction on the drawing is similar to that of FIG. 27 in the embodiment 12, it will be explained also with reference to FIG. 27. The cell delay variation amount holding unit 15 in the embodiment 13 has a function for inputting the signal 14a from the cell delay variation amount calculating unit 14, holding the minimum cell delay variation amount, and sending it as a cell delay variation amount signal 15a.

<Operation>

The operation of the embodiment 13 will now be described hereinbelow also with reference to FIG. 12.

Also in the embodiment, since the process in the transmitting direction is executed, there is no need to consider the cell loss as in case of transmitting the data on the ATM network as in the receiving direction and the UUI code is certainly continuously transmitted, so that the continuous coincidence discrimination of the UUI code is not performed.

First, since the operations which are executed up to the calculation of the cell delay variation amount by the cell delay variation amount calculating unit 14 are similar to those in the embodiments 11 and 12, their descriptions are omitted.

When the measuring state 116 is set to the H level, the cell delay variation amount holding unit 15 receives the signal 14a of the cell delay variation amount calculating unit 14 and compares the reception cell delay variation amount with the previous minimum cell delay variation amount. When a comparison result indicates that it is smaller than the minimum value, it is held as a new minimum value and sent as a signal 15a. Those operations correspond to the packet input 110, phase counter output 5a, coincidence information 12a, packet time counter output 13a, cell delay variation amount calculating unit output 14a, maximum/minimum discriminating times, and cell delay variation amount holding unit output 15a in FIG. 12.

<Effects>

As mentioned above, according to the embodiment 13, in addition to the construction of the embodiment 11, since the measuring state 116 is inputted and the minimum cell delay variation amount within the measuring time is held, the minimum value of the cell delay variation amount on the user side can be known. There is an effect such that since the network administrator knows the minimum cell delay variation amount, the proper cell delay variation absorption amount can be set on the transmission side.

[Use embodiments]

Although the timing at which the trigger state is obtained has been set to the timing of the call setting in the embodiments 1 to 5 and 8 to 13, as other predetermined specific conditions, it is also possible to use a condition such as timing when an alarm state (communication disable state of the transmission or reception) is detected or timing when the alarm state is cancelled. Further, it is also possible to use timing when the number of dissident times of the UUI code is counted by the coincidence loss discriminating unit 12 shown in FIG. 11 and the dissidence continues the predetermined number of times or more.

In the embodiment, although the count-up period of the packet time counter 13 has been fixed, it can be also set from the outside.

Although each of the embodiments 4, 5, 12, and 13 has been described by showing the circuit construction of the hardware, similar functions can be also realized by software. Although the cell delay variation amount has been held in accordance with the measuring state 116, the cell delay variation amount in the call setting time can be also measured on the basis of the call setting 115. Although the timing to hold the cell delay variation amount has been set to the timing of 1 cycle after in which the signal 12c indicative of the continuous coincidence discrimination result shows “1”, it is sufficient to hold it before the signal 12c indicative of the next continuous coincidence discrimination result indicates “1” and such timing does not shows the fixed timing.

Although the test packet has been formed by inputting the payload length and the payload pattern from the outside in the embodiment 6, it can be also preliminarily fixedly determined. By deciding the LI value in the payload length “0”, the test packet without a payload can be also used.

Although the form such that the test code field of the test packet is arranged just after the CPS header has been used in the embodiment 7, it is also possible to arrange it after some payload was inputted. Although the test code has been inputted from the outside, it can be also preliminarily fixedly determined. As a test packet, an alarm packet shown in the ITU-T I.366.2 can be also used.

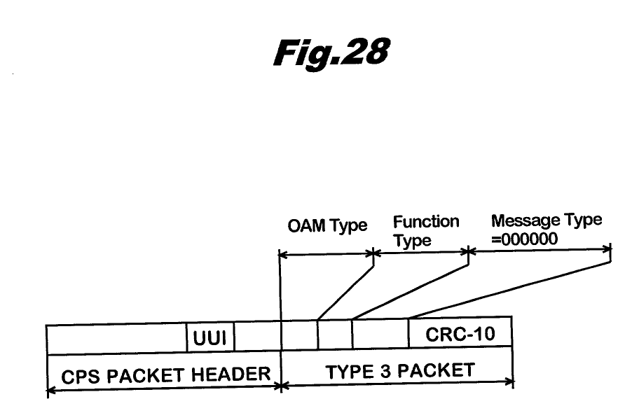

FIG. 28 is an explanatory diagram of a format of an alarm packet.

For example, there is a method of using an OAM Type field as a text code field. However, since no sequence number is allocated to the UUI field of the alarm packet, a method of using a Function Type field as a sequence number or the like can be also used in place of such a method.

Although the embodiment 8 has been shown as a modification of the construction of the embodiment 4 shown in FIG. 13, the modification of the construction of the embodiment 3 shown in FIG. 11 can be also used. As a test packet, an alarm packet shown in the ITU-T I.366.2 can be also used in a manner similar to the case of the embodiment 7.

Although the embodiment 9 has been shown as a modification of the constructions of the embodiments 1 and 3, the modification of the embodiments 1 and 8 can be also used. Although the automatic adjusting interval 119 has been inputted from the outside, a predetermined interval can be also maintained in the apparatus. Although the example of starting the automatic adjustment in dependence on the automatic adjusting state 120 has been shown, the adjustment can be also made in response to the start and end of the call.

Although the enable input 111 has been written and read out into/from the memory 30 in the embodiment 10, it can be also newly formed on the reading side without performing the writing operation.

Although the packet time 114 has been fixed in the embodiment 11, it can be also arbitrarily set from the outside.

The present invention is not limited to the foregoing embodiments but many modifications and variations are possible within the spirit and scope of the appended claims of the invention.

What is claimed is:

1. A cell delay variation absorbing apparatus in a receiving direction for receiving packets which have sequence numbers and are transmitted at regular intervals and executing a cell delay variation absorbing process of reception timing of said packets, comprising
a reception counter which counts the sequence numbers serving as a reference in case of performing the cell delay variation absorbing process of the reception timing of an arbitrary packet and outputs a count value,
wherein a process for synchronizing the sequence number which is outputted from said reception counter and the sequence number of said received packet in consideration of a cell delay variation amount is executed by using a predetermined specific condition as a trigger.

2. An apparatus according to claim 1, wherein
said cell delay variation absorbing process is a process for temporarily writing the received packets into a memory, delaying them by a predetermined time, and sequentially reading out the delayed packets at regular intervals, and
in the case where the specific condition is given, the packets are read out from said memory at the timing which was elapsed by the time corresponding to a cell delay variation absorption amount from said writing operation until the end of said synchronizing process, and in a process other than said synchronizing process, the packets are read out from said memory at regular intervals according to a packet time serving as a predetermined packet transmitting interval.

3. An apparatus according to claim 1, further comprising:
a coincidence loss discriminating unit which discriminates whether said packets have continuously arrived on the basis of the sequence numbers of the packets which are received or not; and
a cell delay variation amount calculating unit which calculates an arrival interval between the packets which continuously arrived in the case where it is determined by said coincidence loss discriminating unit that the packets have continuously arrived, and calculates a difference between a value of said calculation and the packet time as a cell delay variation amount.

4. An apparatus according to claim 2, further comprising:
a coincidence loss discriminating unit which discriminates whether said packets have continuously arrived on the basis of the sequence numbers of the packets which are received or not; and a cell delay variation amount calculating unit which calculates an arrival interval between the packets which continuously arrived in the case where it is determined by said coincidence loss discriminating unit that the packets have continuously arrived, and calculates a difference between a value of said calculation and the packet time as a cell delay variation amount.

5. An apparatus according to claim 3, further comprising a cell delay variation amount holding unit which inputs the cell delay variation amount calculated by said cell delay variation amount calculating unit, compares said inputted value with a previous holding value, updates the cell delay variation amount when the inputted value is larger than said previous value, and holds a maximum cell delay variation amount at that time point.

6. An apparatus according to claim 3, further comprising a cell delay variation amount holding unit which inputs the cell delay variation amount calculated by said cell delay variation amount calculating unit, compares said inputted value with a previous holding value, updates the cell delay variation amount when the inputted value is smaller than said previous value, and holds a minimum cell delay variation amount at that time point.

7. A cell delay variation absorbing apparatus in a transmitting direction for transmitting packets having sequence numbers at regular intervals,
wherein in a state where a user packet is not communicated, a test packet to which a sequence number is added and which is constructed by a predetermined payload length and a payload pattern and used for measuring a cell delay variation amount is formed, and said test packet is transmitted at regular intervals on the basis of a packet time serving as a predetermined packet transmitting interval.

8. A cell delay variation absorbing apparatus in a transmitting direction for transmitting packets having sequence numbers at regular intervals,
wherein a test packet to which a sequence number is added and which is constructed by a predetermined payload length and a payload pattern, has a pattern indicative of a cell delay variation amount test packet at a position in a predetermined packet, and is used for measuring a cell delay variation amount is formed, and said test packet is transmitted at timing when no user packet exists at regular intervals on the basis of a packet time serving as a predetermined packet transmitting interval.

9. An apparatus according to any one of claims 3 to 6, wherein when the test packet to which the sequence number has been added and which has the pattern indicative of said cell delay variation amount test packet at the position in the predetermined packet and is used for measuring the cell delay variation amount is received, by verifying the pattern at the position in said predetermined packet among said packets, it is recognized that said packet is the cell delay variation amount test packet.

10. An apparatus according to any one of claims 3 to 6 and 9, further comprising:
an interval cell delay variation amount holding unit which holds a maximum cell delay variation amount in an arbitrarily determined automatic adjusting interval; and
a packet time calculating unit which adds or subtracts a value of a predetermined packet time on the basis of said maximum cell delay variation amount held in said interval cell delay variation amount holding unit and outputs a resultant cell delay variation amount as a packet time for said cell delay variation absorbing process.

11. A cell delay variation absorbing apparatus in a transmitting direction for transmitting packets having sequence numbers at regular intervals,
wherein when a specific condition is given, transmission timing based on a predetermined cell delay variation absorption amount is set into a user packet and, thereafter, the packets are transmitted at regular intervals on the basis of a packet time serving as a predetermined packet transmitting interval.

12. An apparatus according to claim 11, wherein an arrival interval of the transmission packet is measured, a difference between a value of said measurement and the predetermined packet time is obtained, and said difference value is used as an amount of cell delay variation which was caused on the user side.

13. An apparatus according to claim 12 further comprising measuring state designating means which instructs a start and a stop of the measurement of the cell delay variation amount, and
wherein a maximum cell delay variation amount in an interval designated by said measuring state designating means is held and said maximum cell delay variation amount is outputted as an amount of a maximum cell delay variation which was caused on the user side.

14. An apparatus according to claim 12, further comprising measuring state designating means which instructs a start and a stop of the measurement of the cell delay variation amount, and
wherein a minimum cell delay variation amount in an interval designated by said measuring state designating means is held and said minimum cell delay variation amount is outputted as an amount of a minimum cell delay variation which was caused on the user side.

15. An apparatus according to any one of claims 1, 2, and 11, wherein said specific condition is call setting timing.

16. An apparatus according to any one of claims 1, 2, and 11, wherein said specific condition is timing of detecting an alarm state.

17. An apparatus according to any one of claims 1, 2, and 11, wherein said specific condition is timing of resetting an alarm state.

18. An apparatus according to any one of claims 1, 2, and 11, wherein said specific condition is timing when a dissidence of the UUI codes continues a predetermined number of times or more.
